(19) United States
(12) Patent Application Publication
(10) Pub. No.: US 2005/0278203 A1
(43) Pub. Date: Dec. 15, 2005

(54) Method, apparatus, and computer product for procurement negotiation and alternative negotiation

(75) Inventors: Hitoshi Monma, Kawasaki (JP); Madoka Mitsuoka, Kawasaki (JP); Masashi Uyama, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 10/972,090

(22) Filed: Oct. 25, 2004

(30) Foreign Application Priority Data
Jun. 9, 2004 (JP) 2004-171800

(51) Int. Cl. G06F 17/60

(52) U.S. Cl. 705/7; 705/10

(57) ABSTRACT

A combination of target product, difference between forecasted sales and previous year's sales performance, and data for explaining a reason as negotiation factor data is stored in a database. Moreover, a combination of target product, difference between desired procurement quantity condition and previous year's contract performance, and data for explaining a reason as a negotiation factor is stored in the database. Whether to perform persuasion type negotiation or automatic negotiation between a hotel and a wholesaler is decided based on a difference between other party's proposal and previous year's contract performance, a difference between self-procurement condition and previous year's contract performance, and a negotiation factor.

### BACKGROUND OF THE INVENTION

1) Field of the Invention

The present invention relates to a technology for performing negotiation on quantity or price of products between a supplier and a seller.

2) Description of the Related Art

There is known a technology with which a supplier and a seller can automatically perform negotiations on quantity or price of products. For example, Japanese Patent Application Laid-Open No. 2003-114937 discloses a technology that automates part of the negotiation process between the supplier such as hotel and the seller such as wholesaler in the travel business field. According to the technology disclosed in this publication, the supplier or seller mainly performs demand forecasting of tourists or sales forecasting of product, and proposes the quantity or the price of product to the other party.

In the conventional automatic negotiation, a search type negotiation or a persuasion type negotiation is used to perform a negotiation between the supplier and the seller. The search type negotiation is a method that utilizes a utility function employing parameters such as product price, quantity, transportation commission, date of liquidation, and penalty, intends to search for the optimum point where the value of the utility function is maximized, and performs the negotiation such that both can obtain Win-Win relationship.

The persuasion type negotiation utilizes the method explained in Simon Parsons, “An analysis of formant inter-agent” ACM AAMAS'02 Jul. 15-19, 2002, pp. 394-401. The persuasion type negotiation presents information on which self-proposal is based to the other party together with the self-proposal, and performs the negotiation in favor of self-negotiation.

However, in the conventional technique, since either one of the search type negotiation or the persuasion type negotiation is utilized to perform automatic negotiation between a supplier and a seller, mutual negotiation cannot be efficiently agreed.

For example, when conditions proposed by both sides are greatly different from each other, there is a problem that a value of the utility function used in the search type negotiation cannot be converged easily in the search type negotiation, and there is a problem that the persuasion type negotiation is not suitable for adjustment of detailed parameters contained in the final proposed condition.

In other words, it is a remarkably important object to perform automatic negotiation making use of merits of both the search type negotiation and the persuasion type negotiation.

### SUMMARY OF THE INVENTION

It is an object of the present invention to at least solve the problems in the conventional technology.

A procurement negotiation method according to an aspect of the present invention includes receiving other party's procurement condition indicating any one of a quantity and a price of a product proposed by the other party; selecting between a persuasion type negotiation using a negotiation factor or a search type negotiation using a utility function based on a difference between the other party's procurement condition and an agreed procurement condition indicating the quantity and the price of product previously agreed between the supplier and the seller, and a difference between a self-procurement condition indicating the quantity and the price of self-proposed product and the agreed procurement condition; and creating a proposal based on type of negotiation selected at the switching and transmitting the created proposal to the other party.

A negotiation agent method according to another aspect of the present invention includes receiving a supplier's procurement condition indicating any one of a quantity and a price of a product proposed by a supplier and a seller's procurement condition indicating any one of a quantity and a price of a product proposed by a seller; selecting between a persuasion type negotiation using a negotiation factor or a search type negotiation using a utility function based on a difference between an agreed procurement condition indicating the quantity and the price of product previously agreed between the supplier and the seller and the supplier's procurement condition, and a difference between the agreed procurement condition and the seller's procurement condition; and performing negotiation based on type of negotiation selected at the selecting and notifying a result of the negotiation to the supplier and the seller.

A procurement negotiation apparatus according to still another aspect of the present invention includes a receiving unit that receives other party's procurement condition indicating any one of a quantity and a price of a product proposed by the other party; a selecting unit that selects between a persuasion type negotiation using a negotiation factor or a search type negotiation using a utility function based on a difference between the other party's procurement condition and an agreed procurement condition indicating the quantity and the price of product previously agreed between the supplier and the seller, and a difference between a self-procurement condition indicating the quantity and the price of self-proposed product and the agreed procurement condition; and a proposal creating unit that creates a proposal based on type of negotiation selected at the switching and transmitting the created proposal to the other party.

A negotiation agent apparatus according to still another aspect of the present invention includes a receiving unit that receives a supplier's procurement condition indicating any one of a quantity and a price of a product proposed by a supplier and a seller's procurement condition indicating any one of a quantity and a price of a product proposed by a seller; a selecting unit that selects between a persuasion type negotiation using a negotiation factor or a search type negotiation using a utility function based on a difference between an agreed procurement condition indicating the quantity and the price of product previously agreed between the supplier and the seller and the supplier's procurement condition, and a difference between the agreed procurement condition and the seller's procurement condition; and a negotiation performing unit that performs negotiation based on type of negotiation selected by the selecting unit and notifying a result of the negotiation to the supplier and the seller.

Computer-readable recording mediums according to still other aspects of the present invention store computer programs that realize the above methods on a computer.

The other objects, features, and advantages of the present invention are specifically set forth in or will become apparent from the following detailed description of the invention when read in conjunction with the accompanying drawings.

### BRIEF DESCRIPTION OF THE DRAWINGS

FIG. 1 is a diagram of a system structure of a sales negotiation system according to a first embodiment;

FIG. 2 is a diagram of one example of sub-data 1 calculated by a demand forecasting unit;

FIG. 3 is a diagram of one example where negotiation factor data on forecasted demand data is described in XML;

FIG. 4 is a diagram of one example where negotiation factor data on corrected demand data is described in XML;

FIG. 5 is a diagram of one example where negotiation data on desired procurement quantity and purchase price is described in XML;

FIG. 6 is a diagram of one example where negotiation data on corrected procurement quantity and corrected price is described in XML;

FIG. 7 is a diagram of a sequence example of explanation data generated by a negotiation factor extracting unit;

FIG. 8 is a diagram of one example of a data structure of a wholesaler's negotiation factor database;

FIG. 9 is a diagram of one example of data held by a wholesaler's procurement condition accumulating unit;

FIG. 10 is a diagram of one example of a combination of wholesaler's contract renewal policy and intention;

FIG. 11 is a diagram of one example of a combination of hotel's contract renewal policy and intention;

FIG. 12 is a diagram of one example of a negotiation factor applying rule group;

FIG. 13 is a diagram of one example of a wholesaler's negotiation factor accepting rule;

FIG. 14 is a diagram of one example of a proposal message exchanged in a search type negotiation between a hotel and a wholesaler;

FIG. 15 is a flowchart for explaining a processing procedure of creating a proposal by a wholesaler's search type negotiation unit;

FIG. 16 is a diagram of one example where negotiation factor data on an agreed procurement condition is described in XML;

FIG. 17 is a diagram of a sequence example of explanation data of a negotiation factor on ZXY hotel when a negotiation with YZX hotel is completed;

FIG. 18 is a flowchart for explaining a processing procedure of a negotiation factor creating processing performed by the demand forecasting unit and the negotiation factor extracting unit;

FIG. 19 is a flowchart for explaining a processing procedure of a negotiation factor creating processing performed by a wholesaler's procurement condition generating unit and negotiation factor extracting unit;

FIGS. 20A and 20B are flowcharts for explaining a processing procedure of a negotiation processing performed by a negotiation engine;

FIG. 21 is a diagram of one example of a proposal message transmitted form the hotel;

FIG. 22 is a diagram of one example of a proposal message including a negotiation factor to be transmitted to the hotel;

FIG. 23 is a diagram of one example of a proposal message generated by the hotel based on a negotiation factor accepting rule group;

FIG. 24 is a diagram of one example of a data structure of a hotel's negotiation factor database;

FIG. 25 is a diagram of one example of data held by a hotel's procurement condition accumulating unit;

FIG. 26 is a diagram of one example of a hotel's negotiation factor accepting rule;

FIG. 27 is a flowchart for explaining a processing procedure of creating a proposal by a hotel's search type negotiation unit;

FIGS. 28A and 28B are flowcharts for explaining a processing procedure of a negotiation factor creating processing performed by hotel's procurement condition generating unit and negotiation factor extracting unit;

FIG. 29 is a functional block diagram of a structure of a wholesaler's procurement negotiation device and a hotel's procurement negotiation device which automatically renegotiate;

FIG. 30 is a diagram of one example where negotiation data created by a forecasting/reservation performance collating unit is described in XML;

FIG. 31 is a diagram of a concept of negotiation agent according to a second embodiment; and

FIG. 32 is a block diagram of a system structure of a negotiation agent system according to the second embodiment.

### DETAILED DESCRIPTION

Exemplary embodiments of an apparatus, a method, and a computer product according to the present invention will be explained below in detail with reference to the accompanying drawings. In the embodiments, procurement negotiation devices where respective functions are constituted in a physically independent manner will be explained, but the respective functions may be realized as software to be performed as a procurement negotiation program and a negotiation agent program.

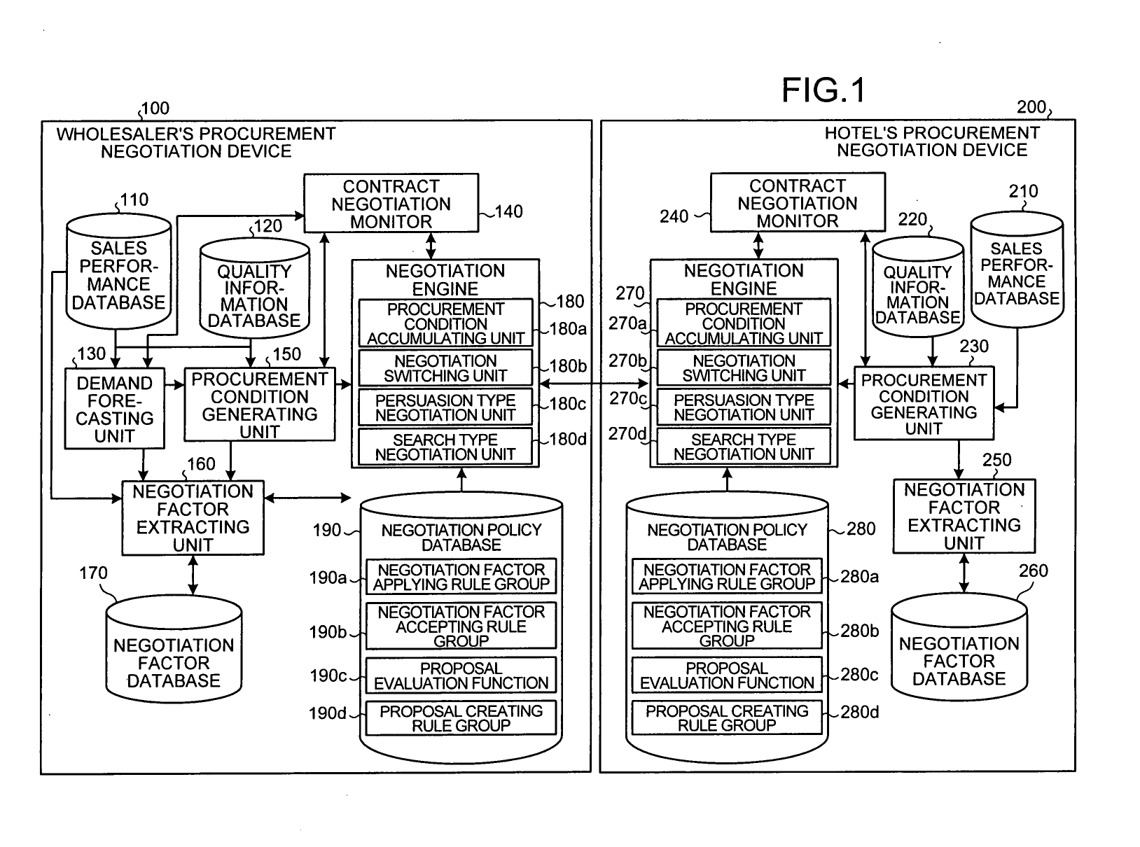

FIG. 1 depicts the system structure of a sales negotiation system according to a first embodiment of the present invention. As depicted, in the sales negotiation system, a wholesaler's procurement negotiation device 100 and a hotel's procurement negotiation device 200 are connected to each other via a network or the like (not shown).

The wholesaler's procurement negotiation device 100 has a sales performance database 110, a quality information database 120, a demand forecasting unit 130, a contract negotiation monitor 140, a procurement condition generating unit 150, a negotiation factor extracting unit 160, a negotiation factor database 170, a negotiation engine 180, and a negotiation policy database 190.

The sales performance database 110 records therein data provided by the third party such as WTO (World Tourism Organization) or wholesaler's past sales performance.

The quality information database 120 holds evaluation files where evaluation information per supplier is registered similarly as in “Method for determining the quantity of commodities to be ordered, center device, and recording medium” disclosed in Japanese Patent Application Laid-Open No. 2002-032633. The evaluation files unify information on the qualities of suppliers such as a distance between a station to a hotel or evaluations by lodgers.

The demand forecasting unit 130 is a processing unit that analyzes data recorded in the sales performance database 110 and forecasts lodgment demand per area utilizing the ARIMA method (described in “Practical tourism Forecasting”, Butterworth-Heimann, 1996 by Douglas C Frechtling and the like).

The demand forecasting unit 130 passes data on the forecasted demand quantity (hereinafter, “forecasted demand data”) to the negotiation factor extracting unit 160 explained later. The demand forecasting unit 130 displays the forecasted demand data via the contract negotiation monitor 140 such as a display, receives correction of the forecasted demand data from an input device (not shown) such as keyboard or mouse, and passes the corrected forecasted demand data (hereinafter, “corrected demand data”) to the negotiation factor extracting unit 160 and the procurement condition generating unit 150.

The demand forecasting unit 130 calculates, as sub-data 1, a variation of the forecasted sales quantity per sales price, forecasted performance set by the wholesaler at a standard commission rate in the variation, a combination of price and optimal quantity which maximizes the forecasted performance (the forecasted performance in the combination will be referred to as maximum target performance), and a target commission which achieves performance equivalent to the maximum target performance in a combination of each price and each quantity. The demand forecasting unit 130 calculates an expected value of the quantity of unsold rooms for the price and the quantity as sub-data 2. The demand forecasting unit 130 not only numerically forecasts lodgment demands per area but also calculates sub-data considering that the demand varies depending on the sales price.

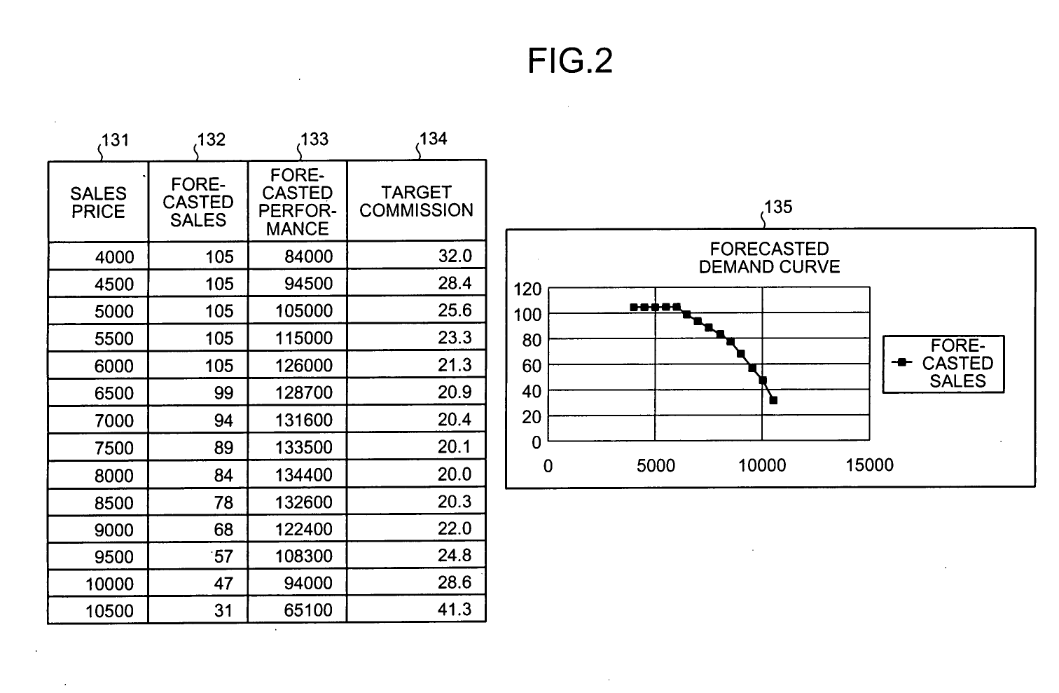

FIG. 2 depicts one example of the sub-data 1 calculated by the demand forecasting unit 130. As depicted, the sub-data 1 includes “sales price” 131, “forecasted sales” 132, “forecasted performance” 133 when the target commission is 20%, and “target commission” 134. Numeral 135 denotes a forecasted sales curve.

From FIG. 2, a combination which achieves the maximum target performance is a contract where the sales price is “8000 yen” and the forecasted sales is “84”, and 134400 yen is a benefit of the wholesaler when the standard commission is 20%.

When the sales price is “4000 yen” and the forecasted sales is “105”, the commission needs to be 32% to achieve the performance equivalent to the maximum target performance. A commission in each price and each quantity for achieving the performance equivalent to the maximum target performance is calculated as a target commission rate in FIG. 2. In the first embodiment, “purchase price” is assumed as “sales price”×(1-commission rate).

Although the more the sales price is, the more the performance is even in the same quantity, a risk of penalty payment due to remnants is also increased. An expected value of the penalty payment can be calculated from the sub-data 2. The sub-data 1 and the sub-data 2 calculated by the demand forecasting unit 130 are utilized in creating a negotiation proposal by the negotiation engine 180 explained later.

The procurement condition generating unit 150 calculates a distribution of the procurement quantity and the purchase price of an accommodation in the corrected forecasted demand data received from the demand forecasting unit 130 based on the quality evaluation for each accommodation accumulated in the quality information database 120. The procurement condition generating unit 150 passes the quantity of procurements and the purchase price calculated to the negotiation factor extracting unit 160.

The procurement condition generating unit 150 displays the quantity of procurements and the purchase price calculated via the contract negotiation monitor 140 and receives corrections of the quantity of procurements and the purchase price from the input device (hereinafter, the corrected quantity of procurements is denoted as the corrected procurement quantity and the corrected purchase price is denoted as the corrected price). The procurement condition generating unit 150 passes the corrected procurement quantity, the corrected price, the target area/target room type, and the like to the negotiation factor extracting unit 160 and the negotiation engine 180.

The negotiation factor extracting unit 160 receives the forecasted demand data and the corrected demand data from the demand forecasting unit 130, and receives the procurement quantity, the purchase price, the corrected procurement quantity, and the corrected price from the procurement condition generating unit 150. The negotiation factor extracting unit 160 creates negotiation factor data based on the respective items of received information, and stores the created negotiation factor data in the negotiation factor database 170.

The negotiation factor data is information on which the contents proposed from the wholesaler to the hotel are based, and is data which leads to the condition advantageous to the wholesaler. For example, it is possible to utilize the above as a market price, contract contents with other company, other product transaction contract contents, evaluation on product quality, and past negotiation factor data. Hereinafter, the negotiation factor data created by the negotiation factor extracting unit 160 will be explained in the order.

When the negotiation factor extracting unit 160 receives the forecasted demand data from the demand forecasting unit 130, the unit 160 acquires the previous year's sales performance from the sales performance database 110, and subtracts the previous year's sales performance from the current year's forecasted demand. The negotiation factor extracting unit 160 accumulates a combination of “target area, difference with previous year, and explanation data” as a negotiation factor in the negotiation factor database 170.

In the first embodiment, parameters which take difference are limited to two parameters of “price and quantity”. The degree of importance may be greatly different between a buyer and a seller for the parameters such as due date, price, quality, and option in purchase of BtoC (Business to Consumer), spot procurement in BtoB (Business to Business), or transaction of novel products or parts.

In a continued transaction relationship such as a transaction between a hotel and a wholesaler in the tour business, a decision as to whether one wants to scale up or down the relationship with the other party is more important. In other words, “price, quantity” is more important than other parameters such as transportation commission, date of liquidation, penalty, and payment method.

The explanation data on the forecasted demand data is composed of “analysis method, analysis data, and demand trend.” Here, the analysis method indicates a name of statistic method such as “ARIMA”, the analysis data indicates target statistical data, and the demand trend indicates a demand fluctuation trend obtained in the process of the statistical analysis such as how many percents of increase is per year. The negotiation factor extracting unit 160 sets an explanation type of the explanation data created when the forecasted demand data is received to “statistic forecasting.”

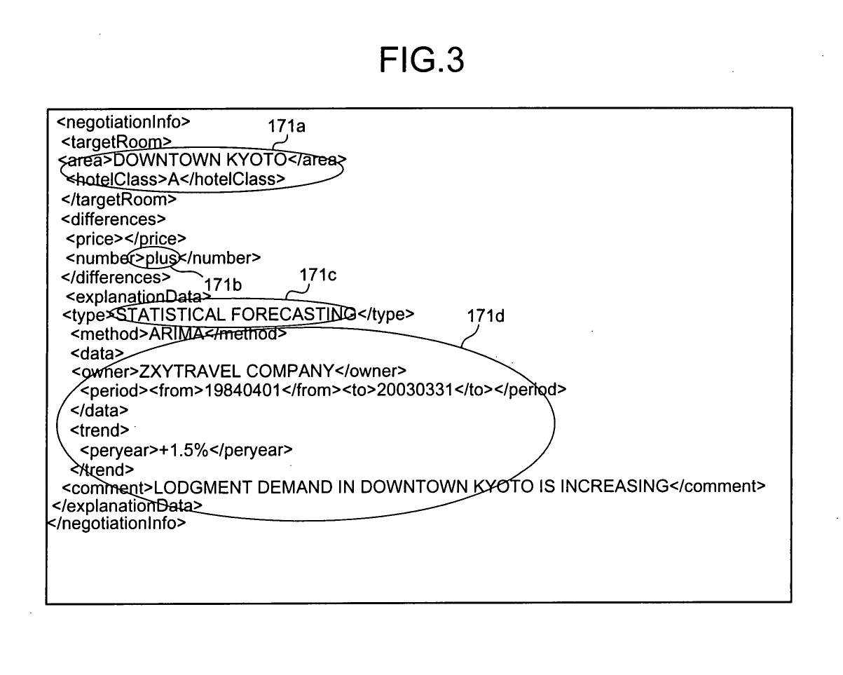

The negotiation factor extracting unit 160 can have a template of typical text to accumulate a comment text such as “a demand of sightseeing in “Kyoto area” is increasing” in the negotiation factor database 170 such that a user can easily make a decision. FIG. 3 depicts one example of the negotiation factor data on the forecasted demand data described in XML (extensible Markup Language).

In FIG. 3, numeral 171a denotes a target area (including hotel class), numeral 171b denotes a sign of a difference result with the previous year, numeral 171c denotes an explanation data type, and numeral 171d denotes explanation data.

Since the negotiation factor data accumulated in the negotiation factor database 170 is transmitted to the hotel's negotiation engine to be processed with a negotiation factor accepting rule explained later, the XML scheme which describes the negotiation factor data needs to be previously agreed in the mutual negotiation engines of the wholesaler and the hotel. The first embodiment is based on the assumption where the XML scheme of the negotiation factor data is defined by industry groups to reduce cost on the transaction in the entire business field.

When the negotiation factor extracting unit 160 receives the corrected demand data from the demand forecasting unit 130, the negotiation factor extracting unit 160 compares it with the previous year's sales performance recorded in the sales performance database 110 and subtracts the previous year's sales performance from the corrected current year's forecasted demand.

The negotiation factor extracting unit 160 accumulates a combination of “target area, difference with previous year, and explanation data” on the corrected demand data as the negotiation factor data in the negotiation factor database.

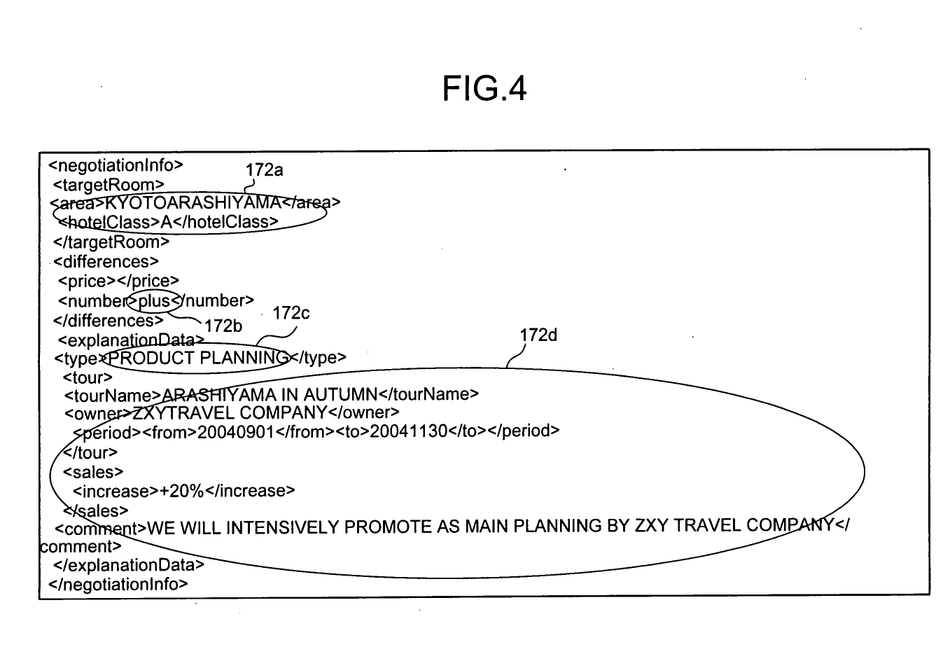

The explanation data on the corrected demand data is composed of “tour product, forecasted performance.” The negotiation factor extracting unit 160 sets the explanation data type of the corrected demand data to “product planning.” FIG. 4 depicts one example where the negotiation factor data on the corrected demand data is described in XML.

In FIG. 4, numeral 172a denotes a target area (including hotel class), numeral 172b denotes a difference with previous year, numeral 172c denotes an explanation data type, and numeral 172d denotes explanation data.

When the negotiation factor extracting unit 160 receives the procurement quantity and the purchase price from the procurement condition generating unit 150, the unit 160 acquires the previous year's procurement quantity and purchase price from the sales performance database 110, subtracts the previous year's procurement quantity from the desired procurement quantity, and subtracts the previous year's purchase price from the desired purchase price.

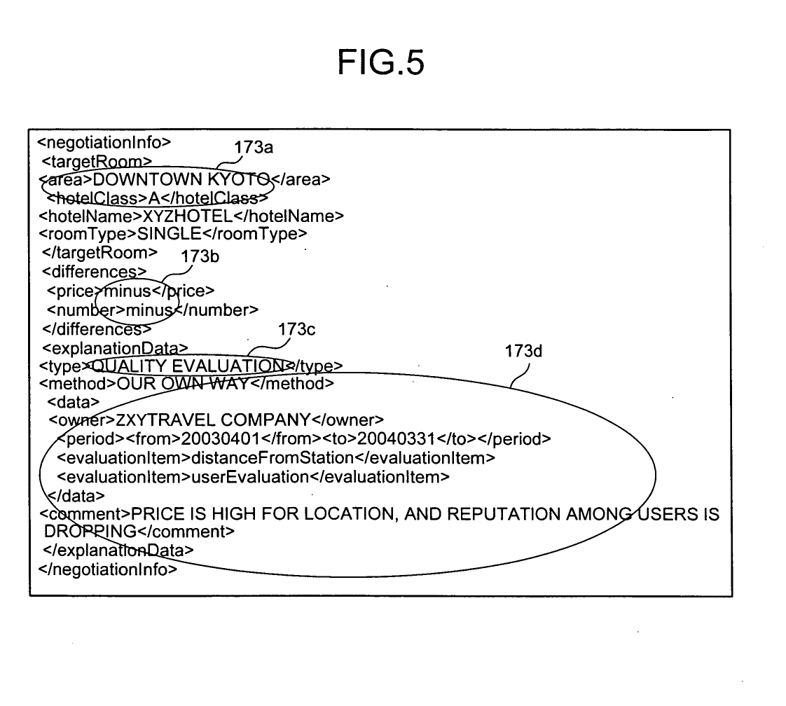

The negotiation factor extracting unit 160 accumulates “target room, difference with previous year, and explanation data” as the negotiation factor data in the negotiation factor database. The explanation data on the desired procurement quantity and purchase price is composed of “analysis method and analysis data.” The negotiation factor extracting unit 160 sets the explanation data type to “quality evaluation.” FIG. 5 depicts one example where the negotiation data on the desired procurement quantity and purchase price is described in XML.

In FIG. 5, numeral 173a denotes a target room (including target area and hotel class), numeral 173b denotes a difference with previous year on the procurement quantity and the purchase price, numeral 173c denotes an explanation data type, and numeral 173d denotes explanation data.

When the negotiation factor extracting unit 160 receives the corrected procurement quantity and the corrected price from the procurement condition generating unit 150, the unit 160 subtracts the previous year's procurement quantity from the corrected procurement quantity and subtracts the previous year's purchase price from the corrected price.

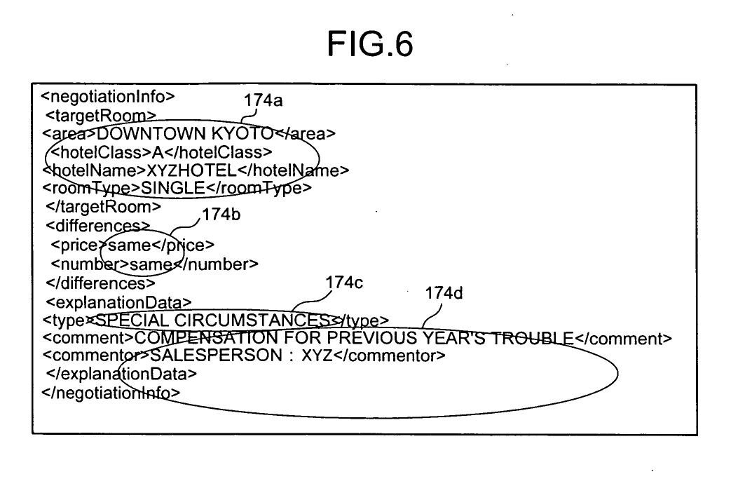

The negotiation factor extracting unit 160 accumulates “target room type, difference with previous year and explanation data” as negotiation factor data in the negotiation factor database. The explanation data on the corrected procurement quantity and the corrected price is composed of only comment input by the user via the input device. The negotiation factor extracting unit 160 sets the explanation data type to “special circumstances.” FIG. 6 depicts one example where the negotiation data on the corrected procurement quantity and the corrected price is described in XML.

In FIG. 6, numeral 174a denotes a target room type (including area information and hotel class), numeral 174b denotes a difference with previous year, numeral 174c denotes an explanation data type, and numeral 174d denotes explanation data.

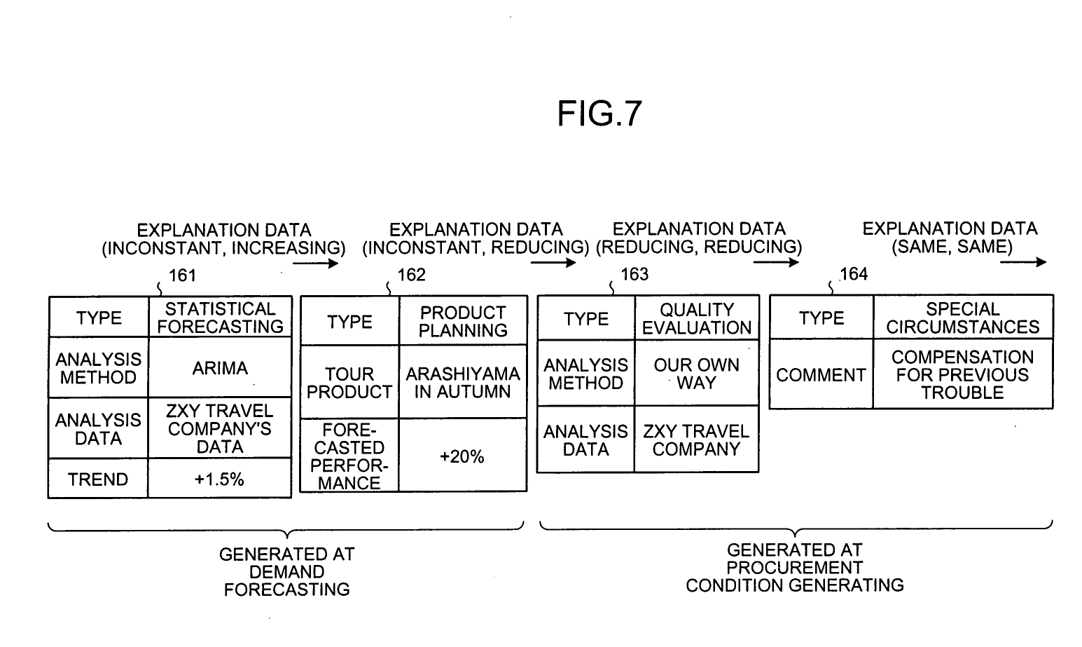

FIG. 7 depicts a sequence example of the explanation data generated by the negotiation factor extracting unit. As depicted, in the first embodiment, statistical forecasting 161 indicates 1.5% of increased demand, and product planning 162 indicates 20% of increased demand. However, decreased transaction of corresponding product is indicated based on quality evaluation 163 so that a procurement policy on the price and the quantity equivalent to the previous year's ones is finally decided in special circumstances 164.

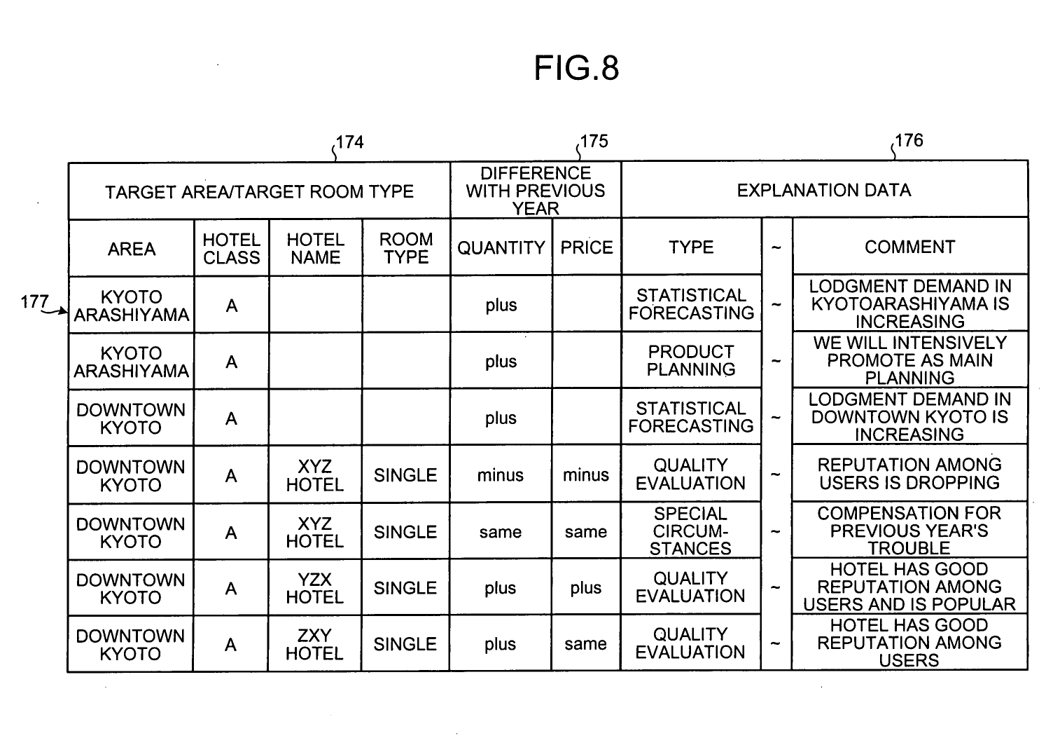

FIG. 8 depicts one example of a data structure of the wholesaler's negotiation factor database 170. As shown in FIG. 8, the negotiation factor database 170 includes target area/target room type 174, difference with previous year 175, and explanation data 176.

The target area/target room type 174 includes “area” indicating area information, “hotel class” indicating a rank of the hotel, “hotel name” indicating the name of the hotel, and “room type” indicating the type of the room.

The difference with previous year 175 includes “quantity” and “price”-indicating a sign of the subtraction result between the previous year's sales performance and the current year's sales quantity, and the explanation data 176 includes “type” and “comment” indicating the explanation data type. For example, the negotiation data 177 indicates the area of “Kyoto Arashiyama”, the hotel class of “A”, the hotel name of “XYZ hotel”, the room type of “single”, the quantity of “minus (indicating a decrease compared with the previous year)”, the price of “minus”, the type of “quality evaluation”, and the comment of “reputation among users is dropping.” Explanation of other negotiation data will be omitted.

The negotiation engine 180 is a processing unit that switches the search type negotiation and the persuasion type negotiation to negotiate with the hotel, and has a procurement condition accumulating unit 180a, a negotiation switching processing unit 180b, a persuasion type negotiation unit 180c, and a search type negotiation unit 180d.

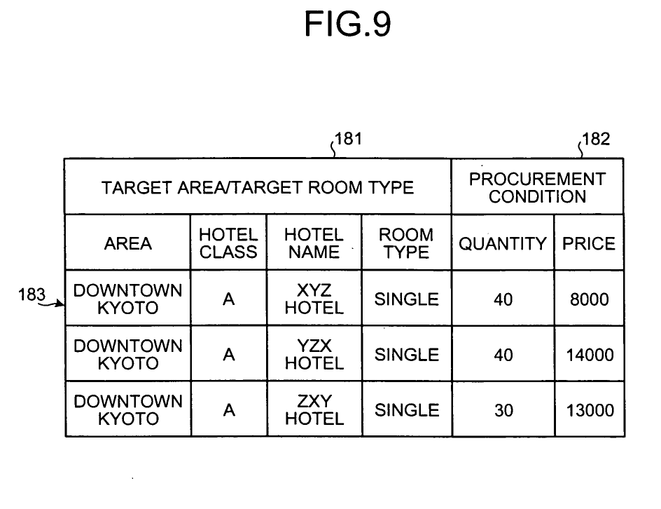

The procurement condition accumulating unit 180a holds data passed from the procurement condition generating unit 150 and the like. FIG. 9 depicts one example of data held by the wholesaler's procurement condition accumulating unit. As depicted, the data held by the procurement condition accumulating unit 180a includes target area/target room type 181 and procurement condition 182. The target area/target room type 181 includes “area”, “hotel class”, “hotel name”, and “room type”, and the procurement condition 182 includes “quantity” and “price.”

For example, the data 183 indicates the area of “downtown Kyoto”, the hotel class of “A”, the hotel name of “XYZ hotel”, the room type of “single”, the quantity of “40”, and the price of “8000”. Explanation of other data held by the procurement condition accumulating unit 180a will be omitted.

The negotiation switching unit 180b utilizes a negotiation factor applying rule group 190a stored in the negotiation policy database 190 to determine whether to perform the persuasion type negotiation or the search type negotiation as the negotiation with the hotel. When the negotiation switching unit 180b determines to perform the persuasion type negotiation, the unit 180b utilizes the persuasion type negotiation unit 180c to negotiate with the hotel, and when the unit 180b determines to perform the search type negotiation, the unit 180b utilizes the search type negotiation unit 180d to negotiate with the hotel.

It is necessary to assume the other party's proposal intention as to whether to apply the negotiation factor. In other words, it is easier to determine the proposal intention by taking whether to be up or down as compared with the previous contract as a reference rather than by simply taking a quantitative difference between the hotel's propose and the self-propose.

For example, when the proposals on the purchase quantity and the price are compared, the following intention can be considered. When the wholesaler proposes the quantity and price lowered as compared with the previous year, the wholesaler would distrust the quality of the corresponding product. Alternatively, it can be determined that the entire market is on a downward trend.

When the hotel proposes to maintain the quantity as is and to increase the product price, it is assumed that the hotel strongly thinks that the product can be sold at the increased price.

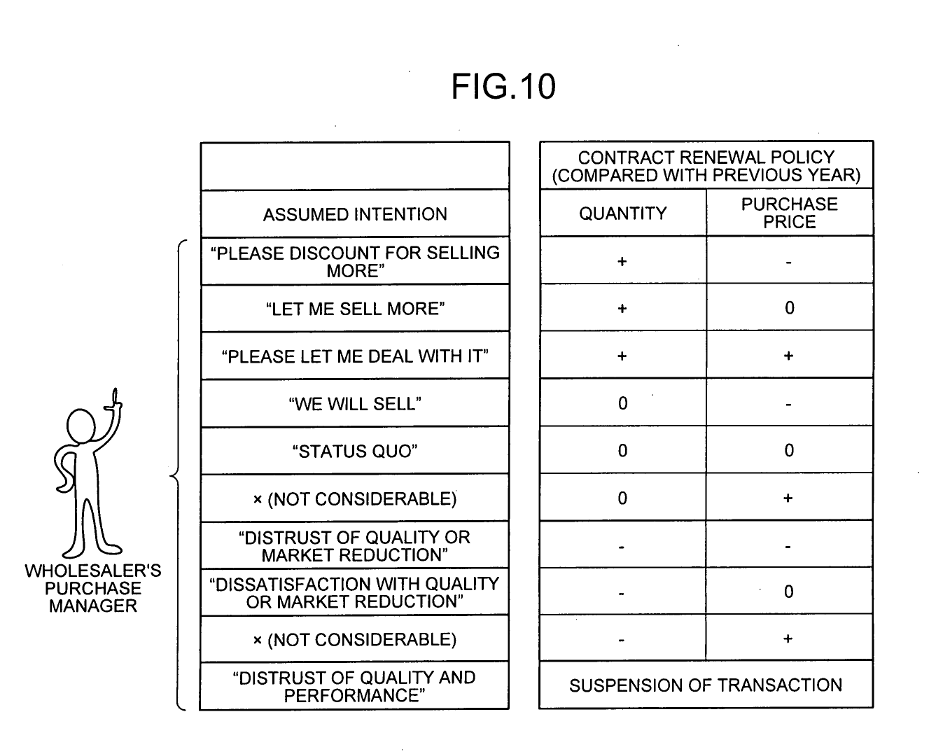

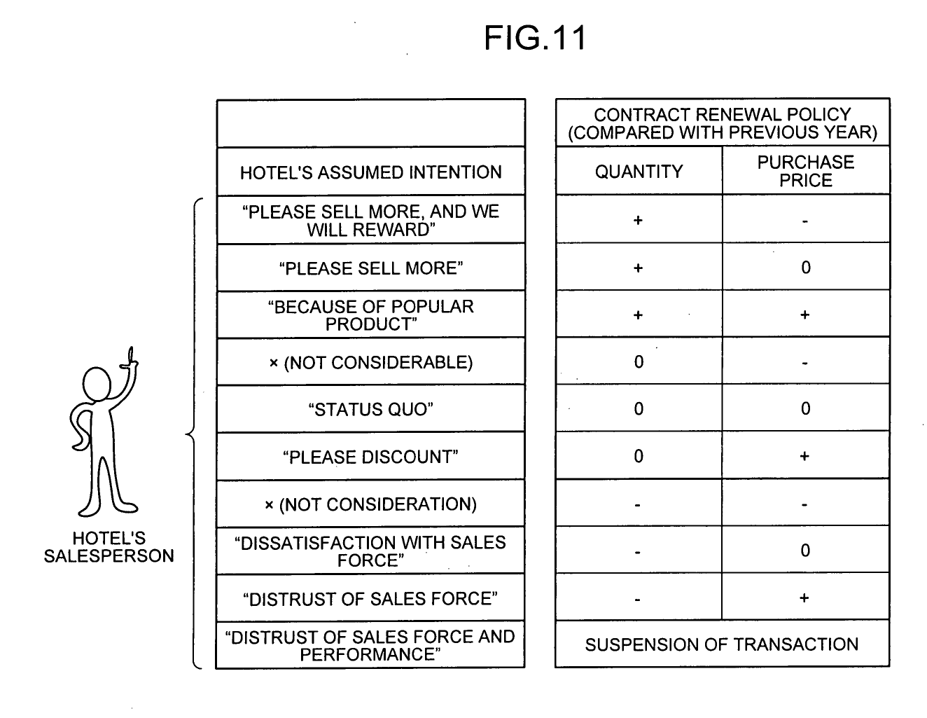

When the other party's intention and our intention are compared with each other, it is possible to determine whether to apply the negotiation factor and which negotiation factor to present to the other party. FIG. 10 depicts one example of a combination of wholesaler's contract renewal policy and intention assumed in the first embodiment, and FIG. 11 depicts one example of a combination of hotel's contract renewal policy and intention.

As shown in FIG. 10, in the contract renewal policy for the difference with previous year at the wholesaler, an assumed intention when the quantity is “plus” and the purchase price is “minus (indicating that the difference with previous year is minus)” is “please discount for selling more”, an assumed intention when the quantity is “plus (indicating that the difference with previous year is plus)” and the purchase price is “zero (indicating no difference with previous year)” is “please let me sell more”, and an assumed intention when the quantity is “plus” and the purchase price is “plus” is “please let me deal with it.”

Similarly, an assumed intention when the quantity is “zero” and the purchase price is “minus” is “We will sell it to you”, and an assumed intention when the quantity is “zero” and the purchase price is “zero” is “the status quo.” It is unlikely that the wholesaler proposes that the quantity is “zero” and only the purchase price is “plus”, and such a situation is assumed to rarely occur.

An assumed intention when the quantity is “minus” and the purchase price is “minus” is “distrust of quality or market reduction”, and an assumed intention when the quantity is “minus” and the purchase price is “zero” is “dissatisfaction with quality or market reduction.” It is unlikely that the wholesaler proposes that the quantity is “minus” and only the purchase price is “plus”, and such a situation is assumed to rarely occur. An assumed intention when “suspension of transaction” is performed is “distrust of quality and performance.”

As shown in FIG. 11, in the hotel's contract renewal policy for the previous year, an assumed intention when the quantity is “plus” and the purchase price is “minus” is “please sell more, and we will reward”, an assumed intention when the quantity is “plus” and the purchase price is “zero” is “please sell more”, and an assumed intention when the quantity is “plus” and the purchase price is “plus” is “because of popular product.”

Similarly, an assumed intention when the quantity is “zero” and the purchase price is “minus” is not considerable as the hotel's proposal, an assumed intention when the quantity is “zero” and the purchase price is “zero” is “the status quo”, and an assumed intention when the quantity is “zero” and the purchase price is “plus” is “please discount.”

An intention when the quantity is “minus” and the purchase price is “minus” is not considerable as the hotel's proposal, an assumed intention when the quantity is “minus” and the purchase price is “zero” is “dissatisfaction with sales force”, and an assumed intention when the quantity is “minus” and the purchase price is “plus” is “distrust of sales force.” An assumed intention when “suspension of transaction” is performed is “distrust of quality and performance.”

A difference between the hotel's proposal and the wholesaler's proposal is simply taken, a degree of the difference between the wholesaler and the hotel can be seen, but the intentions of proposals are unknown. The difference with previous year's performance is taken so that an intention of increased transaction or reduced transaction can be assumed to determine which negotiation factor to use. Each proposal includes many parameters such as transportation commission, penalty, date of liquidation, payment method other than quantity and price, but the negotiation factor applying rule in the first embodiment makes a decision based on only “quantity” and “price.”

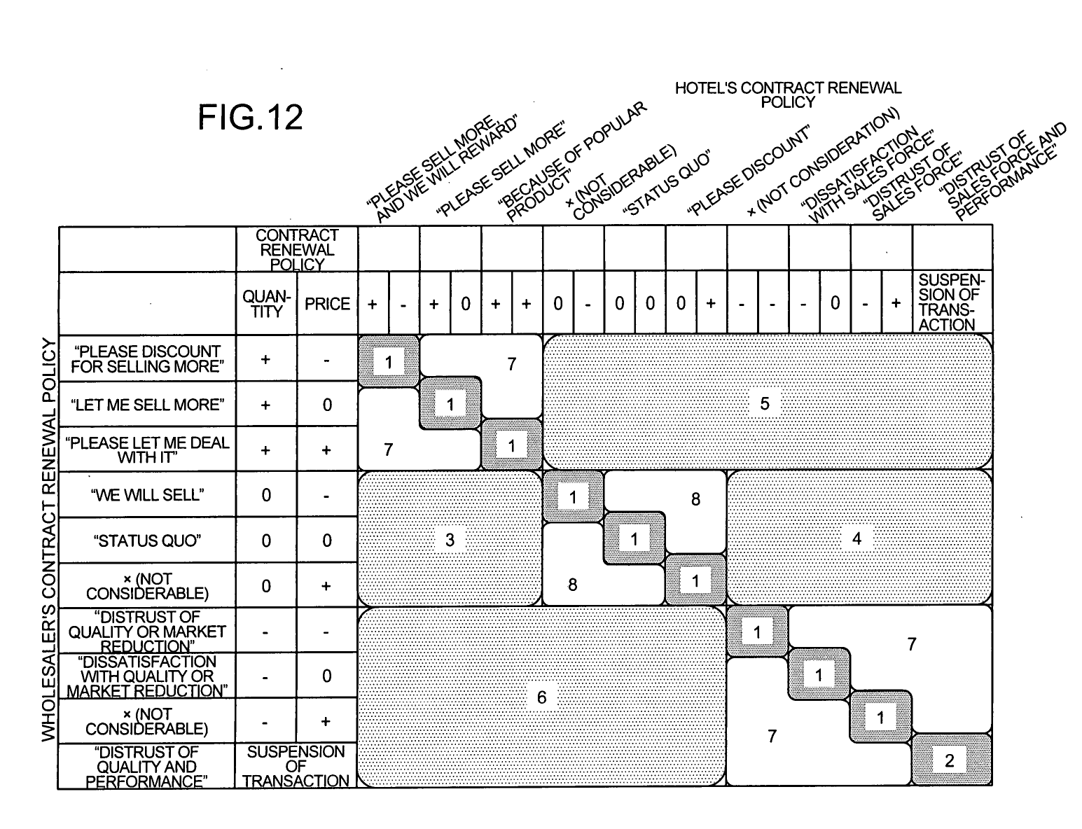

Next, the negotiation factor applying rule group 190a will be explained. FIG. 12 depicts one example of the negotiation factor applying rule group, and two-dimensionally indicates an operation of the rule group. In FIG. 12, the vertical axis indicates a wholesaler's contract renewal policy and the horizontal axis indicates a hotel's contract renewal policy.

In FIG. 12, regions denoted as 1 indicate that opinions of both the wholesaler and the hotel match with each other, and numerical agreements have only to be found so that the negotiation switching unit 180b determines to perform the search type negotiation. A region denoted as 2 indicates that both sides desire suspension of transaction so that negotiation is not required.

Since regions denoted as 3 and 4 indicate that the wholesaler insists on the status quo while the hotel insists on increased transaction or reduced transaction, the negotiation switching unit 180b temporarily selects the search type negotiation and waits for the presentation of negotiation factor from the hotel.

Since a region denoted as 5 indicates that the wholesaler desires increased transaction while the hotel desires the status quo or reduced transaction, and the negotiation factor on which the increased purchase quantity is based requires to be presented from the wholesaler, the negotiation switching unit 180b selects the persuasion type negotiation.

Since a region denoted as 6 indicates that the wholesaler desires reduced transaction while the hotel insists on the status quo, and the negotiation factor on which the reduced purchase quantity is based requires to be presented form the wholesaler, the negotiation switching unit 180b selects the persuasion type negotiation.

Regions denoted as 7 indicate that both basically agree increased transaction or reduced transaction, and numerical agreements have only to be found so that the negotiation switching unit 180b determines to perform the search type negotiation. Since regions denoted as 8 indicate that the maintenance of transaction quantity is matched and only the condition on the price is different, and the negotiation factor on which the increased or reduced price is based requires to be presented if any, the negotiation switching unit 180b determines to perform the persuasion type negotiation.

The persuasion type negotiation unit 180c utilizes the negotiation factor accepting rule group 190b held in the negotiation policy database 190 to determine whether to accept or reject the negotiation factor presented from the other party, alternatively to notify it to the user via the contract negotiation monitor 140, and performs corresponding processing.

The negotiation factor accepting rule in the negotiation factor accepting rule group 190b is a rule described in the form of “IF Condition THEN Action.” The action is roughly classified into the three actions of “accept negotiation factor, create new proposal in consideration of negotiation factor, and present it to the other party”, “ask user (such as human administrator) for decision on negotiation factor”, and “ignore negotiation factor and newly propose.”

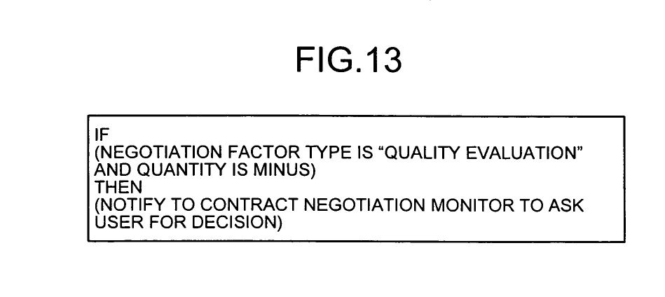

FIG. 13 depicts one example of the wholesaler's negotiation factor accepting rule. As depicted, when the hotel insists on reduced transaction on the strength of the quality evaluation, the persuasion type negotiation unit 180c notifies the fact to the contract negotiation monitor 140 to ask the user for decision.

The negotiation factor accepting rule is described by the user and is previously accumulated in the negotiation policy database 190. The rule is sequentially accumulated as a result of face-to-face negotiation between users or build consensus of the entire business field.

The search type negotiation unit 180d utilizes the proposal evaluation function 190c to negotiate with the hotel. The proposal evaluation function 190c is a utility function which evaluates utility of the transaction condition proposal presented from the other party. The search type negotiation unit 180d utilizes the proposal creating rule group 190d to create a transaction condition proposal to be presented to the hotel.

The search type negotiation unit 180d may employ any existing method. For example, the unit 180d may assume the other party's evaluation function by Case-Based Reasoning (CBR) method as in PERSUADER (Katia Sycara, “Multiagent Compromise via Negotiation” in Distributed Artificial Intelligence Volume II, Les Gasser and Michael N. Huhns edited, Morgan KaufmannPublisher, inc., 1989, pp. 119-137) to create a proposal which increases the other part's and its own evaluation functions, or may repeat proposals which randomly change conditions to search the optimal point without any knowledge on the other party.

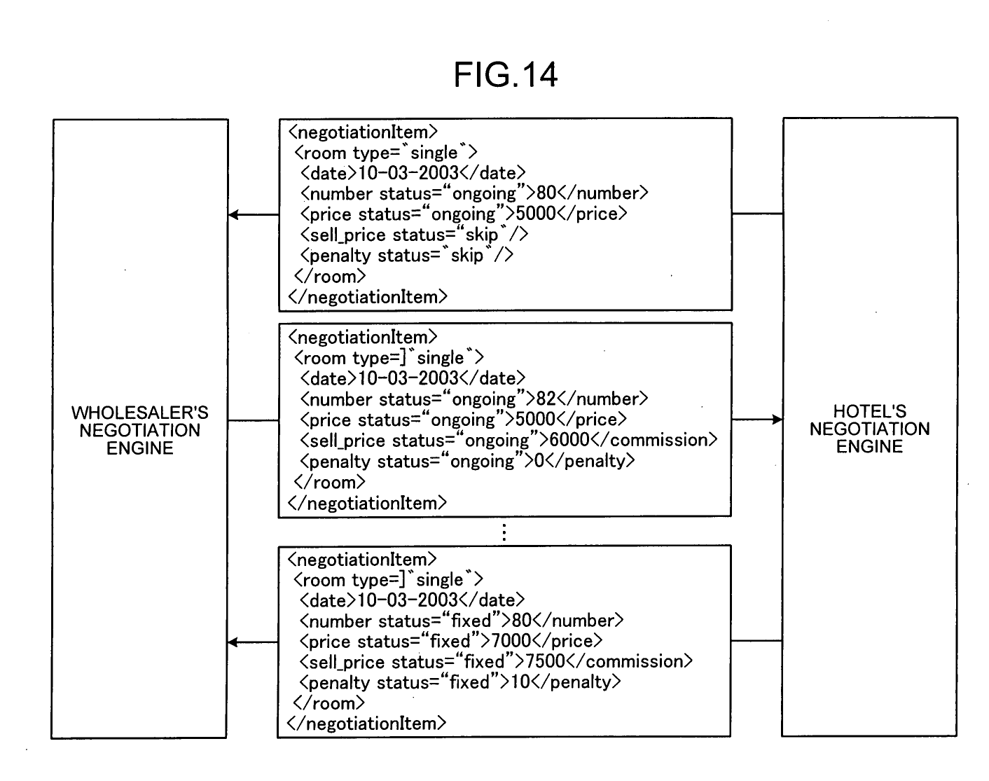

FIG. 14 depicts one example of a proposal message exchanged between the hotel and the wholesaler at the search type negotiation. The data is described in the XML format such as status=“skip”, status=“ongoing”, or status=“fixed” in the message in FIG. 14.

Here, “ongoing” means that there is a room for negotiation on the parameter, “fixed” means that a value of the parameter is agreed, and “skip” means that the parameter is not discussed now. Detailed explanation will be omitted, but after all the parameters enter “skip”, both the hotel and the wholesaler will electronically sign.

The example of the proposal message in FIG. 14 is based on a first assumption to a third assumption. The first assumption indicates that the hotel issues an inquiry message which designates only “price, quantity.” The second assumption indicates that the wholesaler issues a response message which adds “price, quantity, sales price, return penalty rate, forecasted returned room.” The third assumption indicates that only the hotel determines whether the negotiation has been compromised.

It can be considered that the wholesaler's proposal creating rule group 190d makes equivalent options which maximize the wholesaler's own benefit into catalogue from among many combinations of “price (purchase price), quantity, sales price, penalty.”

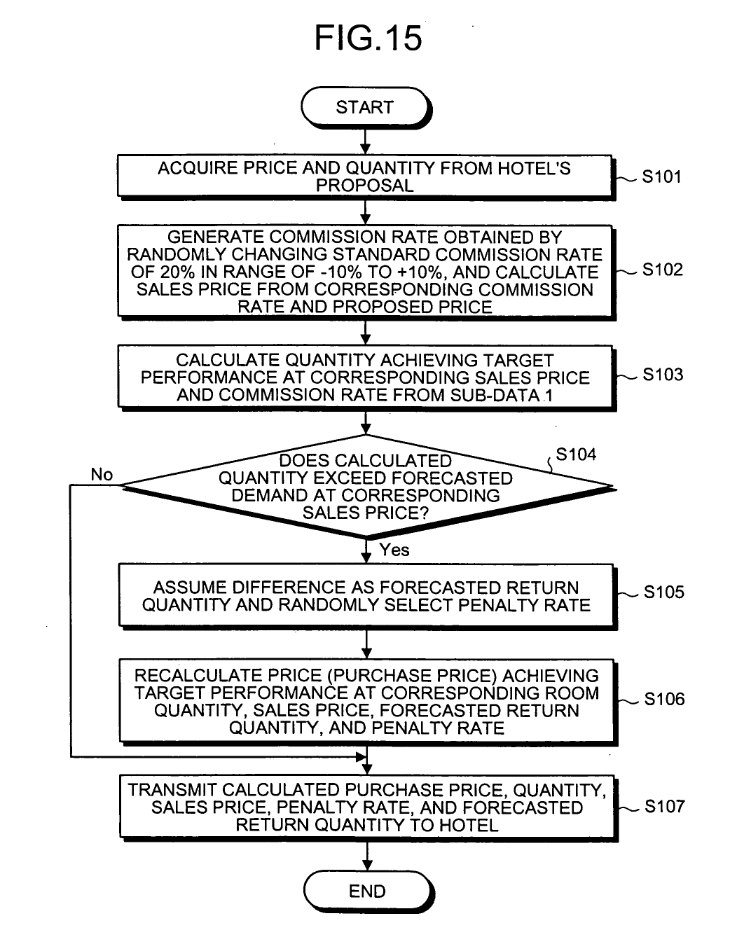

Here, a processing procedure of creating a proposal based on the proposal creating rule group 190d by the search type negotiation unit 180 will be explained. FIG. 15 is a flowchart for explaining the processing procedure of creating a proposal by the search type negotiation processing unit.

As shown in FIG. 15, the search type negotiation unit 180d acquires price and quantity from the hotel's proposal (step S101) to generate a commission rate which is obtained by randomly changing the standard commission rate of 20% in the range of −10% to +10%, and calculates the sales price from the corresponding commission rate and the proposed price (step S102).

The search type negotiation unit calculates the quantity which achieves the target performance (134,400 yen in the first embodiment) at the corresponding sales price and the commission rate from the sub-data 1 (step S103), and determines whether the calculated quantity exceeds the forecasted demand at the corresponding sales price (step S104).

When the calculated quantity exceeds the forecasted demand at the corresponding sales price (Yes in step S104), the wholesaler assumes the difference as the forecasted return quantity and randomly selects the penalty rate (step S105), recalculates the price (purchase price) which achieves the target performance at the room quantity, the sales price, the forecasted return quantity, and the penalty rate (step S106), and transmits the calculated purchase price, the quantity, the sales price, the penalty rate, and the forecasted return quantity to the hotel (step S107).

On the other hand, when the calculated quantity does not exceed the forecasted demand at the corresponding sales price (No in step S104), the processing directly proceeds to step S107.

The negotiation in the first embodiment terminates when the quantity of negotiations by the search type negotiation unit 180d exceeds the upper limit or when the search type negotiation unit 180d cannot create a proposal where the proposal creating rule increases the evaluation function any more.

When the hotel and the wholesaler agree a certain proposal to terminate the negotiation, the agreed procurement condition can be utilized as the negotiation factor data in negotiation with another party. For example, the persuasion type negotiation unit 180c or the search type negotiation unit 180d calculates the difference between the previous year's performance of a hotel and a hotel A's procurement condition for the hotel which provides rooms in the same area, at the same rank, and of the same type against the procurement condition agreed with the hotel A, and passes it to the negotiation factor extracting unit 160.

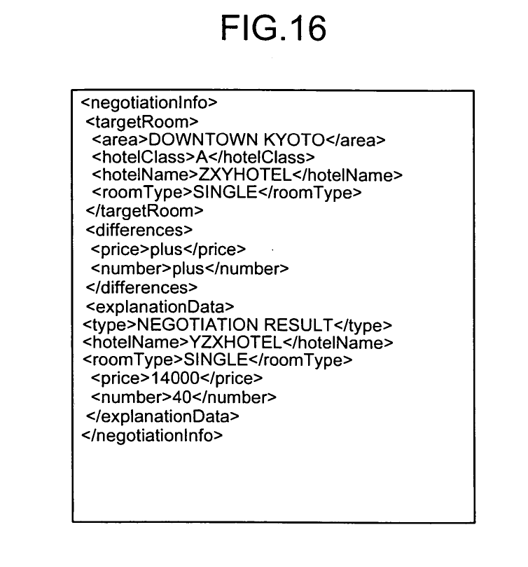

The negotiation factor extracting unit 160 accumulates a combination of the three items of “target room type, difference with previous year, explanation data” for each hotel as the negotiation factor data in the negotiation factor database 170. The procurement condition agreed with the hotel A will be described in the explanation data. FIG. 16 depicts one example where the negotiation factor data on the agreed procurement condition is described in XML.

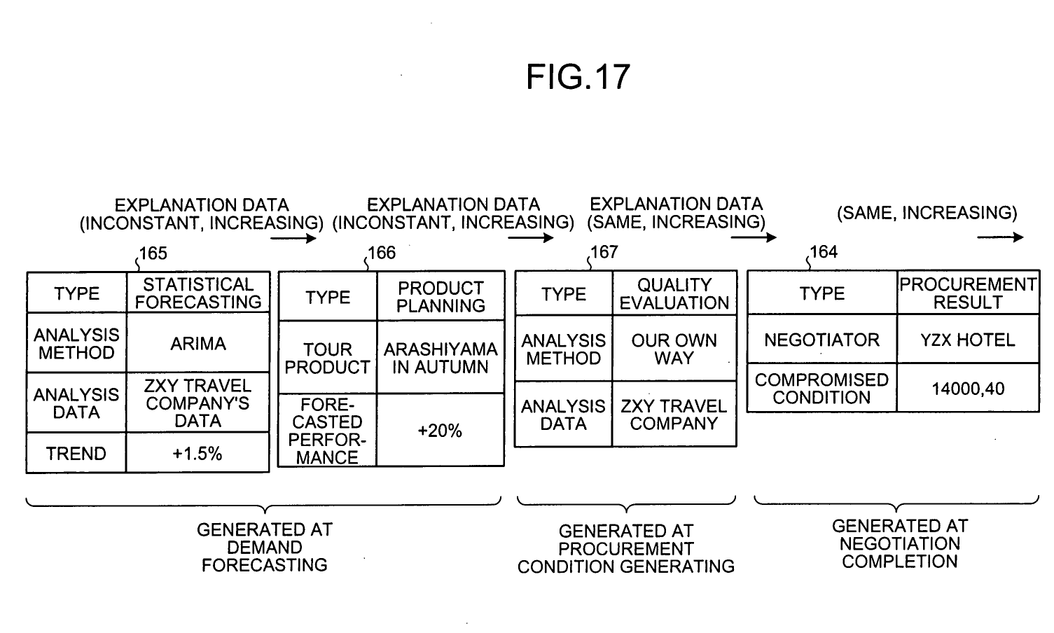

FIG. 17 depicts a sequence example of the explanation data of the negotiation factor on ZXY hotel when the negotiation with YZX hotel is terminated. As depicted, in the first embodiment, statistical forecasting 165 indicates 1.5% of increased demand, and product planning 166 indicates 20% of increased demand. Increased transaction of corresponding product is supported based on quality evaluation 167, and a procurement policy which maintains the same price as the previous year's one and increases the quantity as compared with the previous year is determined based on the negotiation result with YZX hotel. The explanation data on the special circumstances is omitted in FIG. 17.

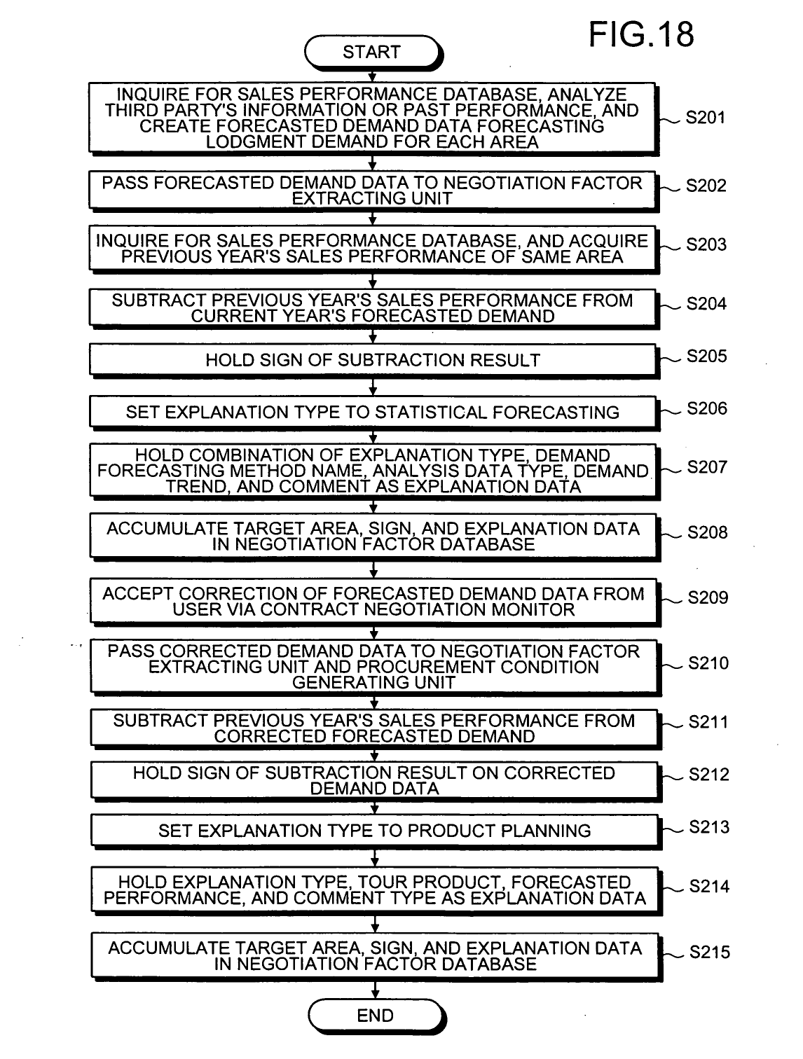

Next, a negotiation factor creating processing performed by the demand forecasting unit 130 and the negotiation factor extracting processing unit 160 will be explained. FIG. 18 is a flowchart for explaining a processing procedure of the negotiation factor creating processing performed by the demand forecasting unit and the negotiation factor extracting unit. As depicted, the demand forecasting unit 130 inquires for the sales performance database 110 to analyze the third party's information or the past sales performance and to create forecasted demand data which forecasts lodgment demand for each area (step S201), and passes the forecasted demand data to the negotiation factor extracting unit 160 (step S202).

The negotiation factor extracting unit 160 inquires for the sales performance database 110 to acquire the previous year's sales performance in the same area (step S203), subtracts the previous year's sales performance from the current year's forecasted demand (step S204), holds a sign of the subtraction result (step S205), and sets the explanation type to statistical forecasting (step S206).

The negotiation factor extracting unit 160 holds a combination of explanation type, demand forecasting method name, analysis data type, demand trend, and comment as the explanation data (step S207), and accumulates the target area (including hotel class), the sign, and the explanation data in the negotiation factor database 170 (step S208).

The demand forecasting unit 130 accepts the correction of the forecasted demand data from the user via the contract negotiation monitor 140 (step S209), and passes the corrected demand data to the negotiation factor extracting unit 160 (step S210).

The negotiation factor extracting unit 160 subtracts the previous year's sales performance from the corrected forecasted demand (step S211), holds a sign of the subtraction result on the corrected demand data (step S212), sets the explanation type to product planning (step S213), holds the explanation type, the tour product, the forecasted performance, and the comment type as the explanation data (step S214), and accumulates the target area, the sign, and the explanation data in the negotiation factor database 170 (step S215).

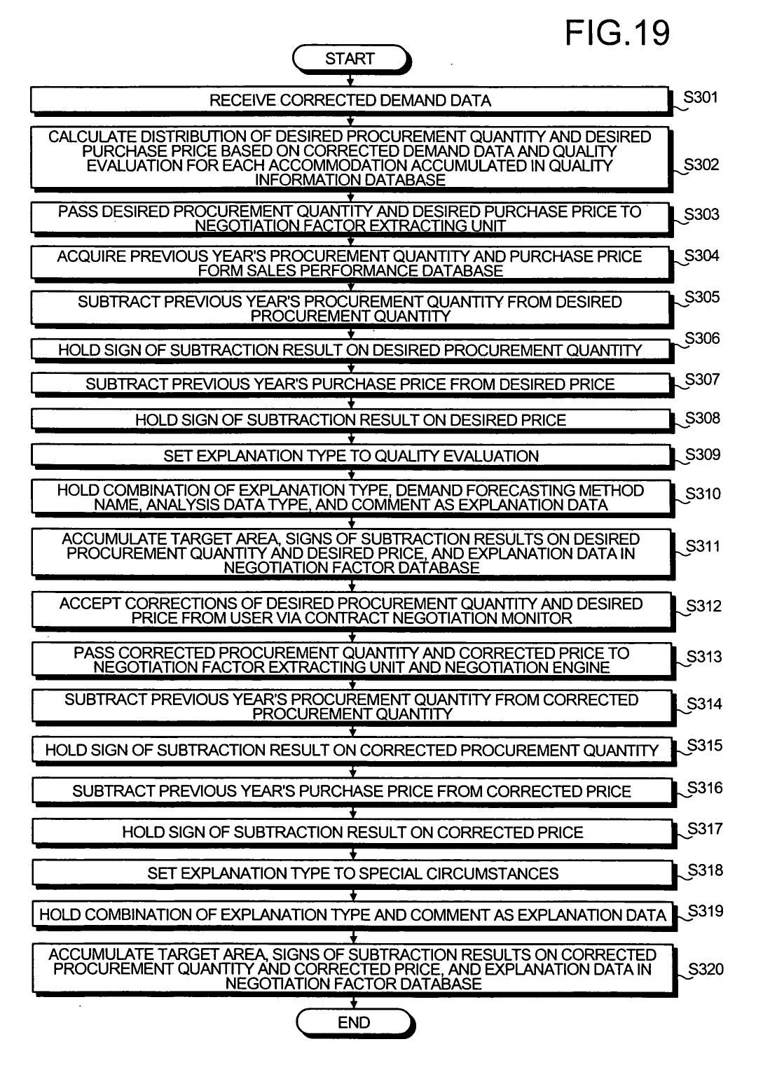

Next, a negotiation factor creating processing performed by the procurement condition generating unit 150 and the negotiation factor extracting unit 160 will be explained. FIG. 19 is a flowchart for explaining a processing procedure of the negotiation factor creating processing performed by the procurement condition generating unit and the negotiation factor extracting unit.

As depicted, the procurement condition generating unit 150 receives the corrected demand data from the demand forecasting unit 130 (step S301), calculates a distribution of the desired procurement quantity and the desired purchase price based on the corrected demand data and the quality evaluation for each accommodation accumulated in the quality information database 120 (step S302), and passes the desired procurement quantity and the desired purchase price to the negotiation factor extracting unit 160 (step S303).

The negotiation factor extracting unit 160 acquires the previous year's procurement quantity and purchase price from the sales performance database 110 (step S304), subtracts the previous year's procurement quantity from the desired procurement quantity (step S305), holds a sign of the subtraction result on the desired procurement quantity (step S306), subtracts the previous year's purchase price form the desired price (step S307), and holds a sign of the subtraction result on the desired price (step S308).

The negotiation factor extracting unit 160 sets the explanation type to quality evaluation (step S309), holds a combination of explanation type, demand forecasting method name, analysis data type, and comment as the explanation data (step S310), and accumulates the target area (including hotel class), the signs of the subtraction results on the desired procurement quantity and the desired price, and the explanation data in the negotiation factor database (step S311).

The procurement condition generating unit 150 accepts the corrections of the desired procurement quantity and the desired price from the user via the contract negotiation monitor 140 (step S312), and passes the corrected procurement quantity, the corrected price, and the like to the negotiation factor extracting unit 160 and the negotiation engine 180 (step S313).

The negotiation factor extracting unit 160 subtracts the previous year's procurement quantity from the corrected procurement quantity (step S314), holds a sign of the subtraction result on the corrected procurement quantity (step S315), subtracts the previous year's purchase price from the corrected price (step S316), holds a sign of the subtraction result on the corrected price (step S317), and sets the explanation type to special circumstances (step S318).

The negotiation factor extracting unit 160 holds a combination of explanation type and comment as the explanation data (step S319), and accumulates the target area, the signs of the subtraction results on the corrected procurement quantity and the corrected price, and the explanation data in the negotiation factor database (step S320).

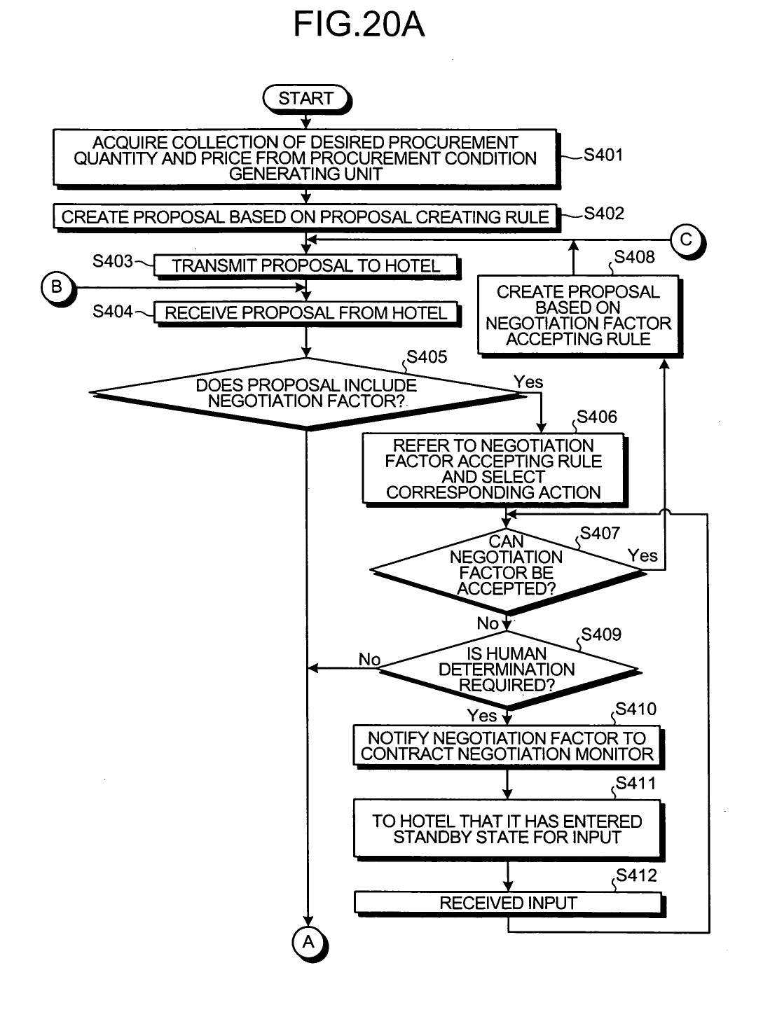

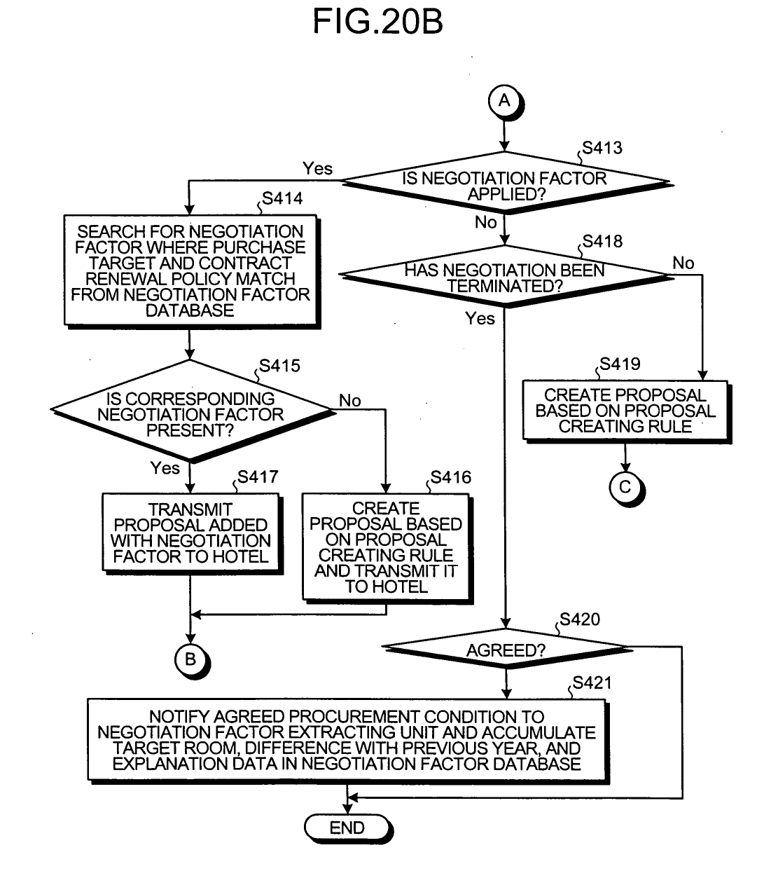

Next, a negotiation processing performed by the negotiation engine 180 will be explained. FIGS. 20A and 20B are flowcharts for explaining a processing procedure of the negotiation processing performed by the negotiation engine 180. As depicted, the negotiation engine 180 acquires a collection of the desired procurement quantity and price from the procurement condition generating unit 150 (step S401), and creates a proposal based on the proposal creating rule (step S402).

The negotiation engine 180 transmits the proposal to the hotel (step S403), receives a proposal from the hotel (step S404), determines whether the proposal includes a negotiation factor (step S405), and when the proposal includes a negotiation factor (Yes in step S405), refers to the negotiation factor accepting rule to select the corresponding action (step S406).

The negotiation engine 180 determines whether the negotiation factor can be accepted (step S407), and when the negotiation factor can be accepted (Yes in step S407), creates a proposal based on the negotiation factor accepting rule (step S408), and the processing proceeds to step S403.

On the other hand, when the negotiation factor cannot be accepted (No in step S407), whether human decision is required is determined (step S419), and when human decision is not required (No in step S419), the processing proceeds to step S413 (step S413 will be explained later).

On the other hand, when human decision is required (Yes in step S419), the negotiation engine 180 notifies the negotiation factor to the contract negotiation monitor 140 (step S410), notifies to the hotel that it has entered the standby state for input (step S411), and receives an input (step S412), and the processing proceeds to step S407.

When the proposal does not include a negotiation factor (No in step S405), the negotiation engine 180 determines whether to apply the negotiation factor based on the negotiation factor applying rule group 190a (step S413), when the negotiation factor is applied (Yes in step S413), causes the negotiation factor extracting unit 160 to search for the negotiation factor whose contract renewal policy matches with the purchase target (step S414), and determines whether the corresponding negotiation factor is present (step S415).

When the corresponding negotiation factor is not present (No in step S415), the search type negotiation unit 180d creates a proposal based on the proposal creating rule and transmits it to the hotel (step S416), and the processing proceeds to step S404.

On the other hand, when the corresponding negotiation factor is present (Yes in step S415), the persuasion type negotiation unit 180c transmits a proposal added with the negotiation factor to the hotel (step S417), and the processing proceeds to step S404.

When the negotiation factor is not applied (No in step S413), the negotiation engine 180 determines whether the negotiation has been terminated (step S418), when the negotiation has not been terminated (No in step S418), the search type negotiation unit 180d creates a proposal based on the proposal creating rule (step S419), and the processing proceeds to step S403.

On the other hand, when the negotiation has been terminated (Yes in step S418), the negotiation engine determines whether to have agreed (step S420), when agreed (Yes in step S420), notifies the agreed procurement condition to the negotiation factor extracting unit 160 to accumulate the target room, the difference with previous year, and the explanation data in the negotiation factor database 170 (step S421). When not agreed (No in step S420), the processing is terminated as it is.

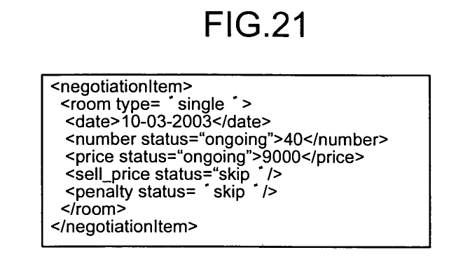

FIG. 21 depicts one example of a proposal message transmitted from the hotel as a specific example of the negotiation processing. When the wholesaler receives the proposal from the hotel in FIG. 21, it takes a difference between the proposal of (40 <quantity>, 9000 <price>) and the previous year's performance since the proposal does not include the negotiation factor.

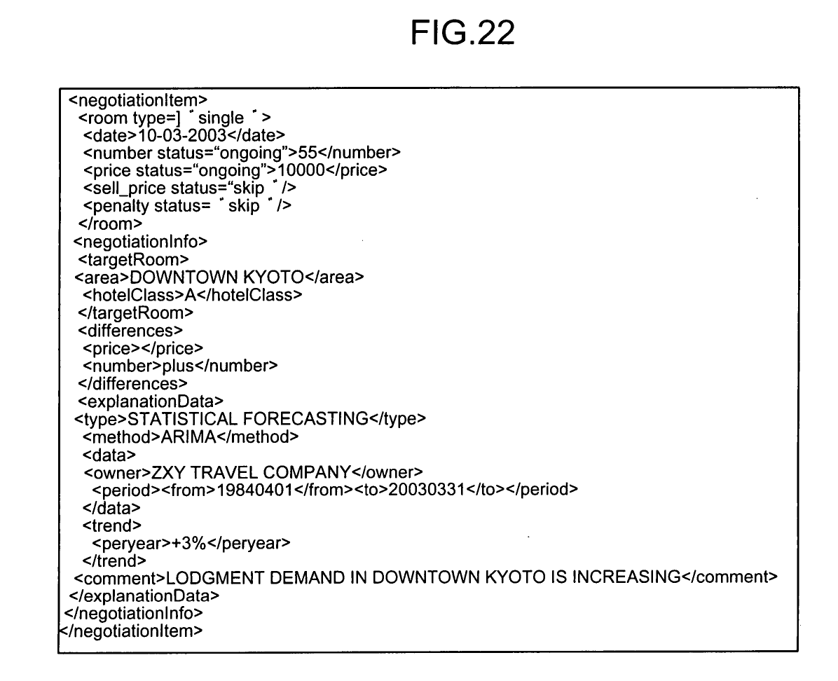

As one example, when the difference between the quantity and price proposed by the hotel and the previous year's performance is zero, and when the difference between the quantity and price desired by the wholesaler and the previous year's performance is plus in both quantity and price, a negotiation factor can be applied from the negotiation factor applying rule group 190a, and the wholesaler transmits the proposal as depicted in FIG. 22 to the hotel.

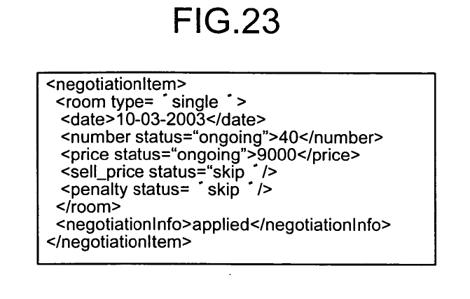

The hotel receives the proposal as depicted in FIG. 22, checks whether the proposal includes a negotiation factor, creates a new proposal based on a negotiation factor accepting rule group 280c explained later, and transmits the proposal as depicted in FIG. 23 to the wholesaler.

Next, a hotel's procurement negotiation device 200 will be explained. The hotel's procurement negotiation device 200 has a sales performance database 210, a quality information database 220, a procurement condition generating unit 230, a contract negotiation monitor 240, a negotiation factor extracting unit 250, a negotiation factor database 260, a negotiation engine 270, and a negotiation policy database 280.

The sales performance database 210, the contract negotiation monitor 240, and the negotiation factor extracting unit 250 are substantially similar to the sales performance database 110, the contract negotiation monitor 140, and the negotiation factor extracting unit 160 in the wholesaler's procurement negotiation device 100, and explanation thereof will be omitted.

The quality information database 220 stores statistical information that forecasts the quantity which the wholesaler can sell based on the wholesaler's past sales performance.

The procurement condition generating unit 230 calculates the desired trust quantity and the desired trust price based on the quality information database 220 similarly as in “Method, system, and device for supply quantity allocation, and recording medium” disclosed in Japanese Patent Application No. 2000-177633, and passes the same to the negotiation factor extracting unit 250.

The procurement condition generating unit 230 displays the desired trust quantity and desired trust price calculated via the contract negotiation monitor 240, and accepts the corrections of the desired trust quantity and the desired trust price from the input device (hereinafter, the corrected desired trust quantity is denoted as corrected trust quantity, and the corrected desired trust price is denoted as corrected trust price). The procurement condition generating unit 230 passes the corrected trust quantity, the corrected trust price, the target room type, and the like to the negotiation factor extracting unit 250 and the negotiation engine 270.

The procurement condition generating unit 230 calculates a sales force rate based on the quality information database 220. The sales force rate indicates the sales capability of the wholesaler at a rate of forecasted sales quantity and sales performance based on the past data. The procurement condition generating unit 230 passes the calculated sales force rate to the negotiation engine 270.

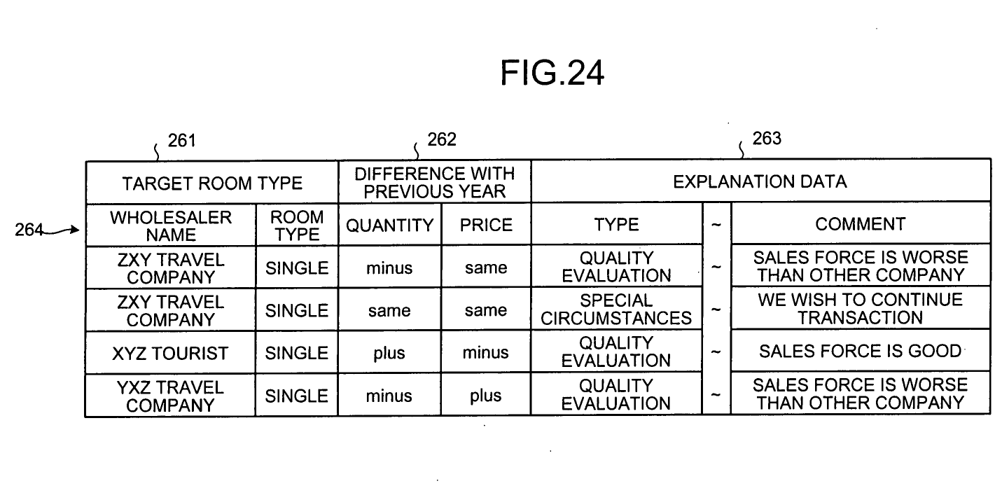

FIG. 24 depicts one example of a data structure of a hotel's negotiation factor database. As depicted, the negotiation factor database 260 includes target room type 261, difference with previous year 262, and explanation data 263.

The target room type 261 includes “wholesaler name” and “room type”, the difference with previous year 262 includes “quantity” and “price”, and the explanation data 263 includes “type” and “comment.”

For example, negotiation factor data 264 indicates the wholesaler name of “ZXY travel company”, the room type of “single”, the quantity of “minus”, the price of “same (same as the previous year's performance)”, the type of “quality evaluation”, and the comment of “sales force is lower than other company.” Explanation of other negotiation factor data will be omitted.

The negotiation engine 270 is substantially similar to the negotiation engine 180 in the wholesaler's procurement negotiation device 100, is a processing unit of switching the search type negotiation and the persuasion type negotiation to negotiate with the wholesaler, and has a procurement condition accumulating unit 270a, a negotiation switching unit 270b, a persuasion type negotiation unit 270c, and a search type negotiation unit 270d.

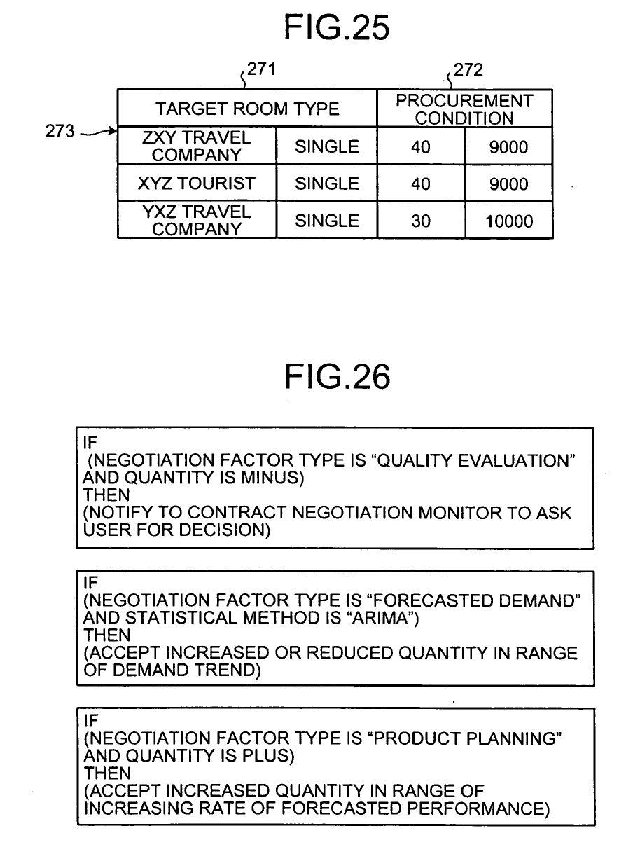

The procurement condition accumulating unit 270a holds data passed from the procurement condition generating unit 230. FIG. 25 depicts one example of data held by the hotel's procurement condition accumulating unit. As depicted, the data held by the procurement condition accumulating unit 270a includes target room type 271 and procurement condition 272.

For example, data 273 indicates that the wholesaler name of the target room type 271 is “ZXY travel company”, the room type is “single”, the procurement condition quantity is “40”, and the price is “9000.” Explanation of other data held by the procurement condition accumulating unit 270a will be omitted.

The negotiation switching unit 270b is substantially similar to the negotiation switching unit 180b in the wholesaler's procurement negotiation device 100, and utilizes a negotiation factor applying rule group 280a recorded in the negotiation policy database 280 to determine whether to perform the persuasion type negotiation or the search type negotiation as the negotiation with the wholesaler.

The negotiation switching unit 270b utilizes the persuasion type negotiation unit 270c to negotiate with the wholesaler when the persuasion type negotiation is determined to be performed, and utilizes the search type negotiation unit 270d to negotiate with the wholesaler when the search type negotiation is determined to be performed. The negotiation factor applying rule group is substantially similar to the negotiation factor applying rule group 190a, and explanation thereof will be omitted.

The persuasion type negotiation unit 270c utilizes the negotiation factor accepting rule group 280b held in the negotiation policy database 280 to determine whether to accept or reject the negotiation factor presented from the other party, or to notify it to the user via the contract negotiation monitor 240, and performs corresponding processing substantially similarly as in the persuasion type negotiation unit 180c in the wholesaler's procurement negotiation device 100.

FIG. 26 depicts one example of the hotel's negotiation factor accepting rule. As depicted, when the wholesaler insists on reduced transaction on the strength of the quality evaluation, the persuasion type negotiation unit 270c notifies the fact to the contract negotiation monitor 240 to ask the user for decision.

When the wholesaler presents the negotiation factor on the forecasted demand and the statistical method “ARIMA”, the persuasion type negotiation unit 270c accepts the increased or reduced quantity in the range of the demand trend.

When the wholesaler insists on increased transaction on the strength of the product planning, the persuasion type negotiation unit 270c accepts the increased quantity in the range of increasing rate of the forecasted performance. The negotiation factor accepting rule is sequentially accumulated as a result of face-to-face negotiation between users or build consensus of the entire business field.

The search type negotiation unit 270d utilizes a proposal evaluation function 280c to negotiate with the wholesaler substantially similarly as in the search type negotiation unit 180d in the wholesaler's procurement negotiation device 100. The proposal evaluation function 280c is also substantially similar to the proposal evaluation function 190c in the wholesaler's procurement negotiation device 100, and explanation thereof will be omitted.

The search type negotiation unit 270d utilizes a proposal creating rule group 280d to create a transaction condition proposal to be presented to the wholesaler. When the negotiation indicated in FIG. 14 is performed with the wholesaler, the search type negotiation unit 270d evaluates “price (purchase price), quantity, sales price, penalty rate, forecasted return quantity” presented from the wholesaler at the function of evaluation value =α×price×(quantity−forecasted return quantity)×sales force rate+penalty rate×price×(quantity−(quantity−forecasted return quantity)×sales force rate) based on the proposal evaluation function 280c.

The sales force rate denotes an evaluation value indicating a degree of accuracy of the wholesaler's forecasting from the hotel standpoint, which takes a numerical value from 0 to 1, and the higher the accuracy of forecasting is, the closer to 1 the value is. Therefore, (quantity−forecasted return quantity)×sales force rate is the actual forecasted sales of the trust sales to the wholesaler from the hotel standpoint. Coefficient α takes a value from 0 to 1. A strategy is different depending on whether to give priority to high price or high penalty because of circumstances of the sales channel for each hotel. The difference of the strategy is reflected on the coefficient α.

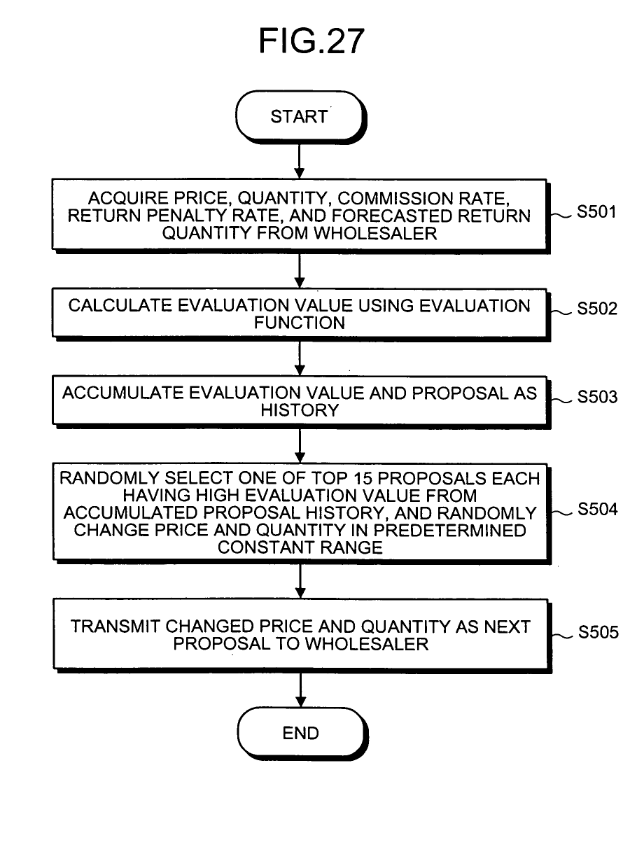

Next, a processing of creating a proposal by the hotel's search type negotiation unit 270d will be explained. FIG. 27 is a flowchart for explaining a processing procedure of creating a proposal by the hotel's search type negotiation unit. As depicted, the search type negotiation unit 270d acquires price, quantity, commission rate, return penalty rate, and forecasted return quantity from the wholesaler (step S501).

The search type negotiation unit 270d uses the function to calculate an evaluation value (step S502), to accumulate the evaluation value and the proposal as history (step S503), to randomly select one of the top 15 proposals each having a high evaluation value from the accumulated proposal history and to randomly change the price and the quantity in the predetermined constant range (step S504), and to transmit the changed price and quantity as a next proposal to the wholesaler (step S505).

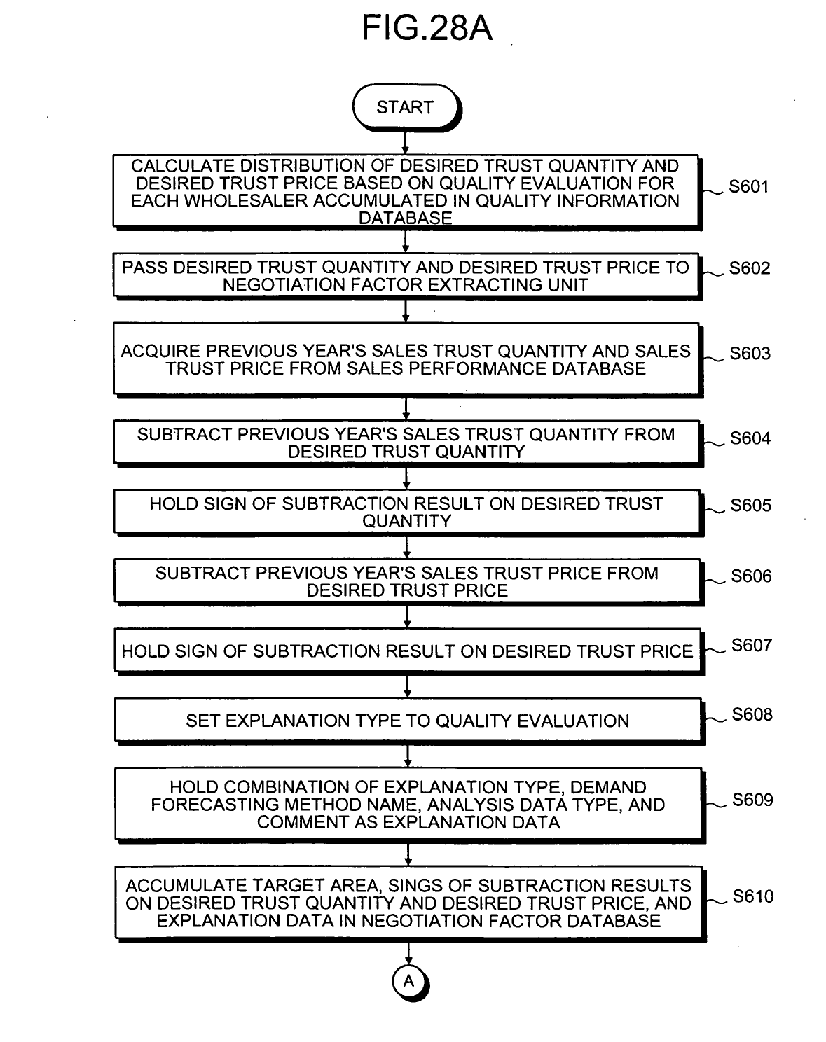

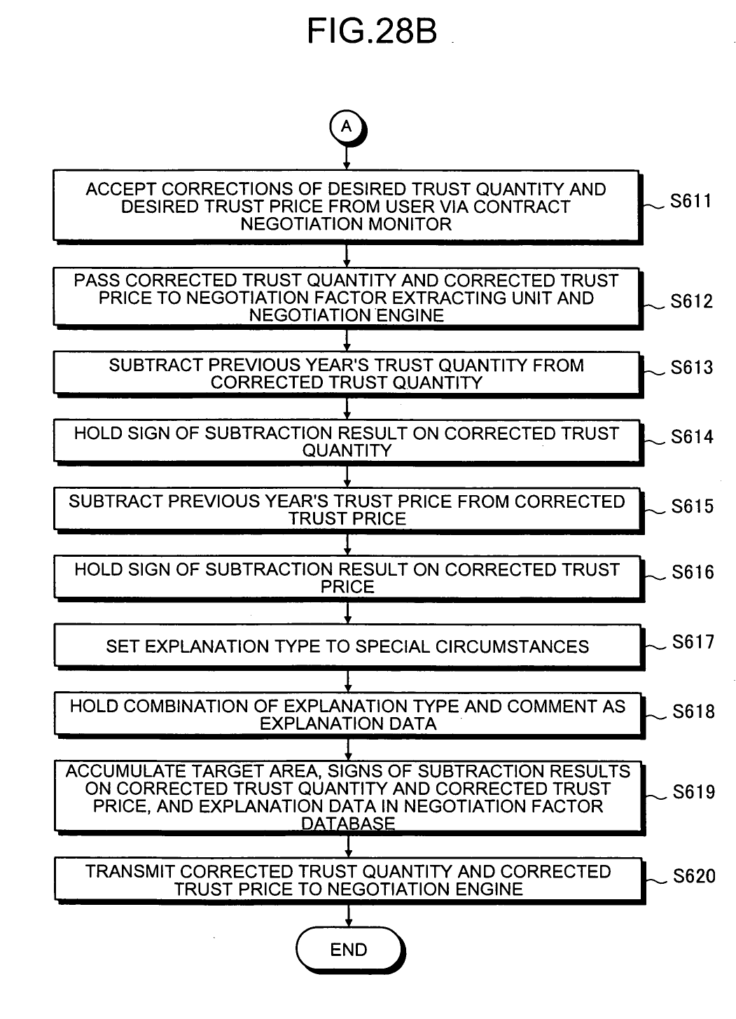

Next, a negotiation factor creating processing performed by the procurement condition generating unit 230 and the negotiation factor extracting unit 250 will be explained. FIGS. 28A and 28B are flowcharts for explaining a processing procedure of the negotiation factor creating processing performed by the hotel's procurement condition generating unit and negotiation factor extracting unit.

As shown in FIG. 28, the procurement condition generating unit 230 calculates a distribution of the desired trust quantity and the desired trust price based on the quality evaluation for each wholesaler accumulated in the quality information database 220 (step S601), and passes the desired trust quantity and the desired trust price to the negotiation factor extracting unit 250 (step S602).

The negotiation factor extracting unit 250 acquires the previous year's sales trust quantity and sales trust price from the sales performance database 210 (step S603), subtracts the previous year's sales trust quantity from the desired trust quantity (step S604), and holds a sign of the subtraction result on the desired trust quantity (step S605).

The negotiation factor extracting unit 250 subtracts the previous year's sales trust price from the desired trust price (step S606), holds a sign of the subtraction result on the desired trust price (step S607), sets the explanation type to quality evaluation (step S608), holds a combination of explanation type, demand forecasting method, analysis data type, and comment as the explanation data (step S609), and accumulates the target area, the signs of the subtraction results on the desired trust quantity and the desired trust price, and the explanation data in the negotiation factor database 260 (step S610).

The procurement condition generating unit 230 accepts the corrections of the desired trust quantity and the desired trust price from the user via the contract negotiation monitor 240 (step S611), and passes the corrected trust quantity and the corrected trust price to the negotiation factor extracting unit 250 and the negotiation engine 270 (step S612).

The negotiation factor extracting unit 250 subtracts the previous year's trust quantity from the corrected trust quantity (step S613), holds a sign of the subtraction result on the corrected trust quantity (step S614), subtracts the previous year's trust price from the corrected trust price (step S615), holds a sign of the subtraction result on the corrected trust price (step S616), and sets the explanation type to special circumstances (step S617).

The negotiation factor extracting unit 250 holds a combination of explanation type and comment as the explanation data (step S618), and accumulates the target area, the signs of the subtraction results on the corrected trust quantity and the corrected trust price, and the explanation data in the negotiation factor database 260 (step S619).

The negotiation processing performed by the negotiation engine 270 is substantially similar as in the flowchart for explaining the processing procedure of the negotiation processing performed by the negotiation engine 180 in FIGS. 20A and 20B, and explanation thereof will be omitted.

As explained above, in the first embodiment, the demand forecasting unit 130 accumulates a combination of target product, difference between the forecasted sales and the previous year's sales performance, and data for explaining the reason as the negotiation factor data in the negotiation factor database 170, and the procurement condition generating unit 150 or 230 accumulates a combination of target product, difference between the desired procurement quantity condition and the previous year's contract performance, and data for explaining the reason as the negotiation factor in the negotiation factor database 170 or 250.

Since the negotiation switching units 180b and 270b can switch the persuasion type negotiation unit 180c and the search type negotiation unit 180d based on the difference between the other party's proposal and the previous year's contract performance, the difference between the self-procurement condition and the previous year's contract performance, and the negotiation factor applying rule group 190a to automatically negotiate with each other, even when the negotiation contents cannot be agreed singly by the persuasion type or the search type unlike conventionally, the agreement can be efficiently reached, thereby reducing load on the user.

When the pace of reservation completions with customers exceeds the forecasting or the pace of reservation completions with customers lowers the forecasting, the wholesaler's procurement negotiation device may automatically renegotiate with the hotel. The hotel's procurement negotiation device may also refer to the room reservation performance for each wholesaler, compare it with other wholesaler, renegotiate the reduced rooms with a wholesaler whose reservation performance is low, and cause a wholesaler whose reservation performance is high to automatically negotiate the increased rooms.

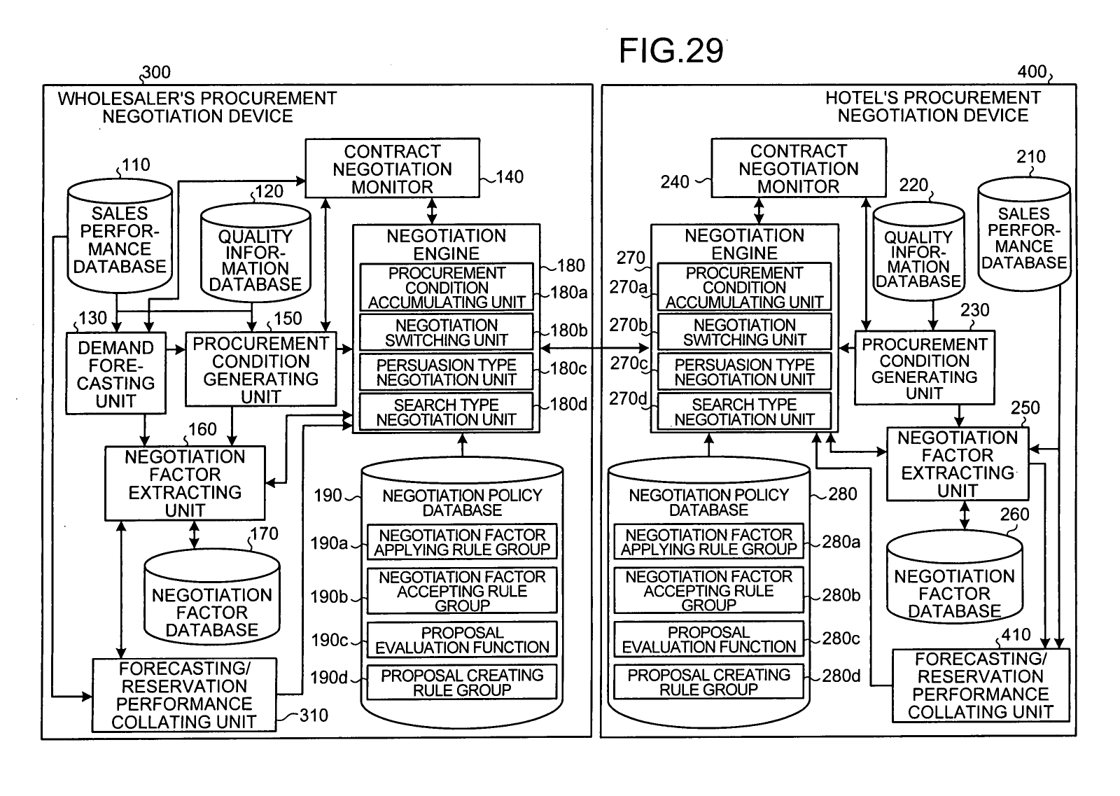

As explained above, the wholesaler's procurement negotiation device and the hotel's procurement negotiation device which automatically renegotiate will be explained. FIG. 29 is a functional block diagram of a structure of the wholesaler's procurement negotiation device and the hotel's procurement negotiation device which automatically renegotiate.

As depicted, the wholesaler's procurement negotiation device 300 has a forecasting/reservation performance collating unit 310. Other structure and functions are similar to those in the wholesaler's procurement negotiation device 100 in FIG. 1, and explanation thereof will be omitted.

The forecasting/reservation performance collating unit 310 periodically acquires the purchase contract quantity, the reservation performance, and the like with the hotel via the sales performance database 110 and the negotiation factor extracting unit 160. When the pace of reservation completions exceeds the forecasting, the unit 310 indicates to renegotiate the increased rooms to the negotiation engine 180.

On the other hand, when the pace of reservation completions lowers the forecasting, the forecasting/reservation performance collating unit 310 notifies to renegotiate the reduced rooms to the negotiation engine 180. Then, the negotiation engine 180 starts the negotiation. Though detailed explanation will be omitted, the forecasting/reservation performance collating unit 310 accumulates the three items of “target room type, difference with previous contract, explanation data” of the data on which the renegotiation is based as the negotiation factor data in the negotiation factor database 170 via the negotiation factor extracting unit 160.

A hotel's procurement negotiation device 400 has a forecasting/reservation performance collating unit 410. Other structure and functions are similar to those in the hotel's procurement negotiation device 200 in FIG. 1, and explanation thereof will be omitted.

The forecasting/reservation performance collating unit 410 periodically refers to the room reservation performance for each wholesaler via the sales performance database 210 and the negotiation factor extracting unit 250, compares it with other wholesaler, and notifies that it causes a wholesaler whose reservation performance is low to start renegotiation on the reduced rooms to the negotiation engine 270.

On the other hand, the forecasting/reservation performance collating unit 410 notifies that it causes a wholesaler whose reservation performance is high to renegotiate the increased rooms to the negotiation engine 270. Though detailed description will be omitted, the forecasting/reservation performance collating unit 410 accumulates the three items of “target room type, difference with previous contract, explanation data” of the data on which the renegotiation is based as the negotiation factor data in the negotiation factor database 260 via the negotiation factor extracting unit 250. Not the difference with the previous year's performance but the difference with the previous purchase contract is calculated, and the explanation data indicates the unsold quantity.

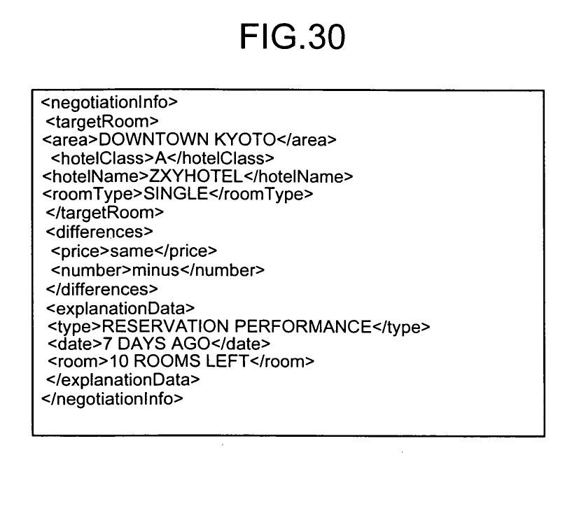

FIG. 30 depicts one example where negotiation data created by the forecasting/reservation performance collating unit 410 is described in XML. As depicted, the data indicates 10 rooms are unsold seven days ago, whose contents support the reduced rooms.

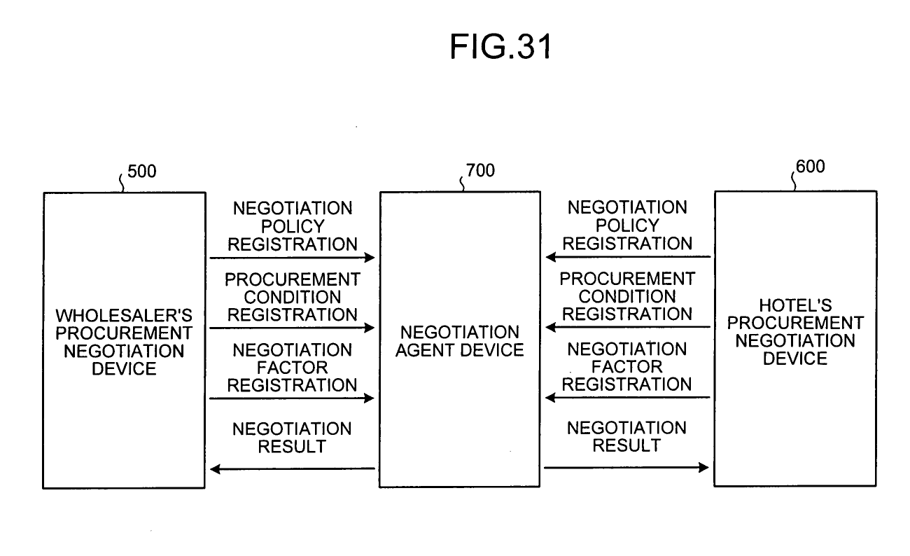

FIG. 31 is a diagram for explaining a concept of negotiation agent according to a second embodiment of the present invention. As shown in this figure, a wholesaler's procurement negotiation device 500 and a hotel's procurement negotiation device 600 transmit negotiation policy data, procurement condition data, and negotiation factor data to a negotiation agent device 700 that acts for negotiation by both sides.

Here, the negotiation policy data (negotiation factor applying rule group, negotiation factor accepting rule group, proposal evaluation function, proposal creating rule, and the like), the procurement condition data (information on the quantity, the price, and the like of a desired room), and the negotiation factor data are substantially similar to those in the first embodiment, and explanation thereof will be omitted.

The negotiation agent device 700 performs automatic negotiation based on the negotiation policy data, the procurement condition data, and the negotiation factor data received from the wholesaler's procurement negotiation device 500 and the hotel's procurement negotiation device 600, and transmits the negotiation result to the wholesaler's procurement negotiation device 500 and the hotel's procurement negotiation device 600.

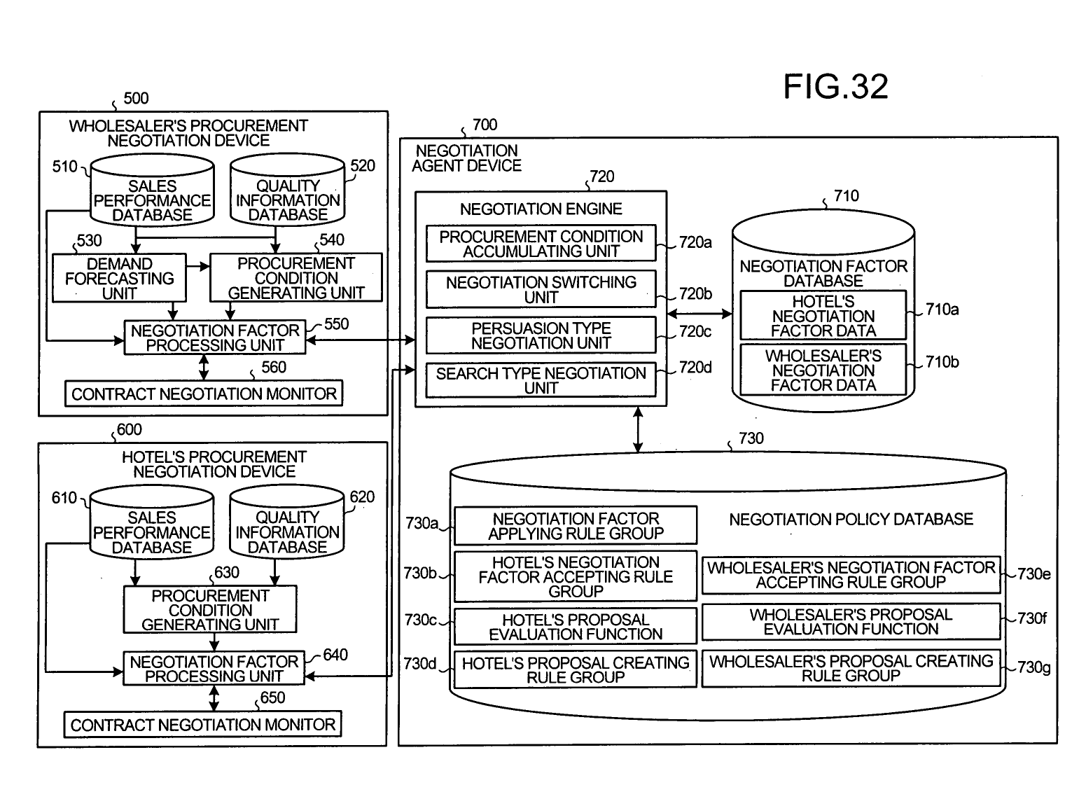

FIG. 32 is a block diagram of a system structure of a negotiation agent system according to the second embodiment. As depicted, the wholesaler's procurement negotiation device 500 and the negotiation agent device 700 are connected to each other, and the hotel's procurement negotiation device 600 and the negotiation agent device 700 are connected to each other.

The wholesaler's procurement negotiation device 500 has a sales performance database 510, a quality information database 520, a demand forecasting unit 530, a procurement condition generating unit 540, a negotiation factor processing unit 550, and a contract negotiation monitor 560.

The sales performance database 510, the quality information database 520, the demand forecasting unit 530, and the procurement condition generating unit 540 are substantially similar to the sales performance database 110, the quality information database 120, the demand forecasting unit 130, and the procurement condition generating unit 150 explained in the first embodiment, and explanation thereof will be omitted.

The negotiation factor processing unit 550 receives wholesaler's procurement condition data from the demand forecasting unit 530 and the procurement condition generating unit 540, and generates the negotiation factor data based on the received procurement condition data and the sales performance database 510. A processing of generating the negotiation factor data is similar to the processing performed by the negotiation factor extracting unit 160 in the first embodiment, and explanation thereof will be omitted.

The negotiation factor processing unit 550 transmits the received wholesaler's procurement condition data and the generated negotiation factor data to the negotiation agent device 700.

The negotiation factor processing unit 550 receives the negotiation policy data from the contract negotiation monitor 560, and transmits the received negotiation policy data to the negotiation agent device 700.

When the negotiation factor processing unit 550 receives a negotiation result from the negotiation agent device 700, the unit 550 displays the received negotiation result on the contract negotiation monitor 560. When the negotiation factor processing unit 550 receives a notification to ask the user for decision from the negotiation agent device 700, the unit 550 displays the fact on the contract negotiation monitor 560, receives corresponding information, and transmits the received information to the negotiation agent device 700.

The hotel's procurement negotiation device 600 has a sales performance database 610, a quality information database 620, a procurement condition generating unit 630, a negotiation factor processing unit 640, and a contract negotiation monitor 650.

The sales performance database 610, the quality information database 620, and the procurement condition generating unit 630 are substantially similar to the sales performance database 210, the quality information database 220, and the procurement condition generating unit 230 in the first embodiment, and the negotiation factor processing unit 640 and the contract negotiation monitor 650 are substantially similar to the negotiation factor processing unit 550 and the contract negotiation monitor 560 in the wholesaler's procurement negotiation device 500, and explanation thereof will be omitted.

The negotiation agent device 700 has a negotiation factor database 710, a negotiation engine 720, and a negotiation policy database 730.

The negotiation factor database 710 has hotel's negotiation factor data 710a and wholesaler's negotiation factor data 710b. Here, the hotel's negotiation factor data 710a is negotiation factor data transmitted from the hotel's procurement negotiation device 600, and the wholesaler's negotiation factor data 710b is negotiation factor data transmitted from the wholesaler's procurement negotiation device 500. These negotiation factor data are accumulated via the negotiation engine 720.

The negotiation engine 720 has a procurement condition accumulating unit 720a, a negotiation switching unit 720b, a persuasion type negotiation unit 720c, and a search type negotiation unit 720d. The procurement condition accumulating unit 720a accumulates the procurement condition data transmitted from the wholesaler's procurement negotiation device 500 and the hotel's procurement negotiation device 600.

The negotiation switching unit 720b is a processing unit that determines whether to perform the persuasion type negotiation or the search type negotiation based on the signs (on quantity and price) included in the procurement condition data of both the wholesaler and the hotel accumulated in the procurement condition accumulating unit 720a and a negotiation factor applying rule group, and switches to the persuasion type negotiation unit 720c or the search type negotiation unit 720d. The negotiation factor applying rule group 730a is similar to the negotiation factor applying rule group 190a in the first embodiment, and explanation thereof will be omitted.

The persuasion type negotiation unit 720c is a processing unit that utilizes the hotel's negotiation factor data 710a, the wholesaler's negotiation factor data 710b, a hotel's negotiation factor accepting rule group 730b, and a wholesaler's negotiation factor accepting rule group 730e to perform persuasion type automatic negotiation. The persuasion type automatic negotiation is substantially similar to the persuasion type automatic negotiation performed by the negotiation engines 180 and 270 in the first embodiment.

The hotel's negotiation factor accepting rule group 730b and the wholesaler's negotiation factor accepting rule group 730e are similar to the negotiation factor accepting rule groups 190b and 280b.

The search type negotiation unit 720b is a processing unit that utilizes a hotel's proposal evaluation function 730c, a hotel's proposal creating rule group 730d, a wholesaler's proposal evaluation function 730f, and a wholesaler's proposal creating rule group 730g to perform search type negotiation. The search type negotiation is also substantially similar to the search type automatic negotiation performed by the negotiation engines 180 and 270 in the first embodiment.

The hotel's proposal evaluation function 730c and the hotel's proposal creating rule group 730d are substantially similar to the proposal evaluation function 280c and the proposal creating rule group 280d, and the wholesaler's proposal evaluation function 730f and the wholesaler's proposal creating rule group 730g are substantially similar to the proposal evaluation function 190c and the proposal creating rule group 190d.

The negotiation agent processing performed by the negotiation engine 720 is substantially similar to the negotiation processing performed by the negotiation engines 180 and 270 in the first embodiment, and explanation thereof will be omitted. When the negotiation engine 720 determines that there is the need to ask the user for decision, the negotiation engine 720 notifies the fact to the wholesaler's procurement negotiation device 500 or the hotel's procurement negotiation device 600, and restarts the negotiation processing after the response therefrom.

As explained above, in the second embodiment, since the wholesaler's procurement negotiation device 500 and the hotel's procurement negotiation device 600 transmit the negotiation policy data, the procurement condition data, and the negotiation factor data to the negotiation agent device 700, and the negotiation switching unit 720 of the negotiation agent device 700 switches to the persuasion type negotiation unit 720c or the search type negotiation unit 720d to act for the negotiation based on the mutual procurement condition data or the negotiation factor applying rule group 730a, and notifies the negotiation result to the wholesaler's procurement negotiation device 500 and the hotel's procurement negotiation device 600, it is possible to efficiently negotiate between the wholesaler and the hotel.

According to the present invention, negotiations can be performed automatically by making use of merits of both the persuasion type negotiation and the search type negotiation thereby efficiently performing the negotiation between the supplier and the seller.

According to the present invention, the negotiation factor can be utilized to perform the negotiation to one's advantage.

According to the present invention, negotiation can be performed rapidly between the supplier and the seller.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

1. A computer-readable recording medium that stores therein a computer program that causes a computer execute:
receiving other party's procurement condition indicating any one of a quantity and a price of a product proposed by the other party;
selecting between a persuasion type negotiation using a negotiation factor or a search type negotiation using a utility function based on a difference between the other party's procurement condition and an agreed procurement condition indicating the quantity and the price of product previously agreed between the supplier and the seller, and a difference between a self-procurement condition indicating the quantity and the price of self-proposed product and the agreed procurement condition; and
creating a proposal based on type of negotiation selected at the switching and transmitting the created proposal to the other party.

2. The computer readable recording medium according to claim 1, further causes the computer to execute searching the negotiation factor for supporting the self-procurement condition from a storage unit when the persuasion type negotiation is selected at the selecting.

3. The computer readable recording medium according to claim 1, further causes the computer to execute creating the negotiation factor based on a past sales performance on product stored in a storage unit.

4. The computer readable recording medium according to claim 1, wherein the selecting includes selecting the persuasion type negotiation when a negotiation factor is added to the other party's procurement condition.

5. A computer-readable recording medium that stores therein a computer program that causes a computer to execute:
receiving a supplier's procurement condition indicating any one of a quantity and a price of a product proposed by a supplier and a seller's procurement condition indicating any one of a quantity and a price of a product proposed by a seller;
selecting between a persuasion type negotiation using a negotiation factor or a search type negotiation using a utility function based on a difference between an agreed procurement condition indicating the quantity and the price of product previously agreed between the supplier and the seller and the supplier's procurement condition, and a difference between the agreed procurement condition and the seller's procurement condition; and
performing negotiation based on type of negotiation selected at the selecting and notifying a result of the negotiation to the supplier and the seller.

6. A procurement negotiation method comprising:
receiving other party's procurement condition indicating any one of a quantity and a price of a product proposed by the other party;
selecting between a persuasion type negotiation using a negotiation factor or a search type negotiation using a utility function based on a difference between the other party's procurement condition and an agreed procurement condition indicating the quantity and the price of product previously agreed between the supplier and the seller, and a difference between a self-procurement condition indicating the quantity and the price of self-proposed product and the agreed procurement condition; and
creating a proposal based on type of negotiation selected at the switching and transmitting the created proposal to the other party.

7. The procurement negotiation method according to claim 6, further comprising searching the negotiation factor for supporting the self-procurement condition from a storage unit when the persuasion type negotiation is selected at the selecting.

8. A negotiation agent method comprising:
receiving a supplier's procurement condition indicating any one of a quantity and a price of a product proposed by a supplier and a seller's procurement condition indicating any one of a quantity and a price of a product proposed by a seller;
selecting between a persuasion type negotiation using a negotiation factor or a search type negotiation using a utility function based on a difference between an agreed procurement condition indicating the quantity and the price of product previously agreed between the supplier and the seller and the supplier's procurement condition, and a difference between the agreed procurement condition and the seller's procurement condition; and
performing negotiation based on type of negotiation selected at the selecting and notifying a result of the negotiation to the supplier and the seller.

9. A procurement negotiation apparatus comprising:
a receiving unit that receives other party's procurement condition indicating any one of a quantity and a price of a product proposed by the other party;
a selecting unit that selects between a persuasion type negotiation using a negotiation factor or a search type negotiation using a utility function based on a difference between the other party's procurement condition and an agreed procurement condition indicating the quantity and the price of product previously agreed between the supplier and the seller, and a difference between a self-procurement condition indicating the quantity and the price of self-proposed product and the agreed procurement condition; and
a proposal creating unit that creates a proposal based on type of negotiation selected at the switching and transmitting the created proposal to the other party.

10. A negotiation agent apparatus comprising:
a receiving unit that receives a supplier's procurement condition indicating any one of a quantity and a price of a product proposed by a supplier and a seller's procurement condition indicating any one of a quantity and a price of a product proposed by a seller;
a selecting unit that selects between a persuasion type negotiation using a negotiation factor or a search type negotiation using a utility function based on a difference between an agreed procurement condition indicating the quantity and the price of product previously agreed between the supplier and the seller and the supplier's procurement condition, and a difference between the agreed procurement condition and the seller's procurement condition; and
a negotiation performing unit that performs negotiation based on type of negotiation selected by the selecting unit and notifying a result of the negotiation to the supplier and the seller.
